(19) United States
(12) Patent Application Publication
(10) Pub. No.: US 2012/0179727 A1
(43) Pub. Date: Jul. 12, 2012

(54) INTERACTIVE HOME MANUAL WITH NETWORKED DATABASE

(76) Inventor: Marla J. Esser, Eureka, MO (US)

(21) Appl. No.: 13/345,735

(22) Filed: Jan. 8, 2012

Related U.S. Application Data
(60) Provisional application No. 61/430,948, filed on Jan. 7, 2011.

(51) Int. Cl. G06F 17/30; G06F 15/16

(52) U.S. Cl. 707/802

(57) ABSTRACT

A interactive home manual system has a centralized database that stores datasets with user account information, home locations, home feature descriptions, home feature information, home feature codes and a set of correlations between the stored data. A centralized computer processor has an account management module, an interactive user operations module, and an administrative operations module. The account management module correlates user accounts with the user account information in the centralized database while the operations module produces the set of correlations for the users' respective accounts and the administrative operations module manages the database. The centralized computer processor is in local communication with the centralized database and in networked communication with the users through a centralized communications module. The users preferably identify the features for their homes using feature codes that can be scanned or otherwise entered through a mobile communications device or manually.

### CROSS-REFERENCE TO RELATED APPLICATIONS

This application claims priority from U.S. Provisional Patent Application No. 61/430,948 filed on Jan. 7, 2011.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to home manuals, and more particularly to an interactive system for creating and maintaining home manuals.

2. Related Art

Published documents, including issued patents and published patent applications, describe computer systems that collect and disseminate household information and allow users to coordinate repair and maintenance services and that track items in a database.

Known systems do not provide a centralized repository of information about home features that users can select to uniquely define the features in their homes as in the present invention. Additionally, current systems do not use any codes that users can scan or otherwise enter to the system through a mobile communications device to particularly identify the features in their homes.

### SUMMARY OF THE INVENTION

The present invention includes a centralized database, a centralized computer processor and a centralized communications module that permits users to communicate with the computer processor and database. The database stores datasets with user account information, home locations, home features, information related to the home features, and a set of correlations between the home locations and home features. The computer processor has an account management module, an interactive user operations module, and an administrative operations module. The account management module correlates the users' accounts with the user account information in the database. The user operations module produces the correlations for the users' respective accounts, and the administrative operations module manages the database. The present invention also includes a correlation between a set of codes and corresponding features. The users preferably scan or otherwise enter the codes into the system through a mobile communications device to particularly identify the features in their homes.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and accompanying drawings, wherein:

FIG. 1 is a block diagram of the system according to the present invention.

FIG. 2 is a flowchart of the system according to the present invention.

FIGS. 3 and 4 are schematic representations of the system according to the present invention.

FIG. 5 is a flowchart of data entry using a mobile communications device to scan codes.

FIGS. 6-30 are screen shots of the system in operation.

### DETAILED DESCRIPTION OF THE PREFERRED EMBODIMENTS

The following description of the preferred embodiment(s) is merely exemplary in nature and is in no way intended to limit the invention, its application, or uses.

The HomeNav system is an online, interactive home guide that provides users with a centralized repository for and interactive access to maintenance, warranty and operations information about their homes' features, including systems, fixtures, appliances, and components. The system uses a combination of online resources and an information repository, such as technical specifications, maintenance and operations manuals, and warranty documents on the homes' features from many different manufacturers, producers, builders, contractors and service providers. Where more detailed, user-specific or local information is used, the HomeNav system guides the user through the process of locating the information from reference web links and then storing the information in the on-line repository.

The HomeNav system is implemented as a web and/or mobile device application and includes a convenient resource guide with links to information about maintaining and operating a home, tips for green and energy-efficient living and targeted education about home components. The HomeNav system can be used by the members of the home building and home services industries (real estate, insurance, contractors, etc.) as a tool for their projects. These industry members (IM) can track and safeguard important information about their customers' homes and the components used to construct and furnish them. The industry members can add and update the specifics for each customer's home or project in the HomeNav system to provide a customized, value-added resource for their clients. The home building professionals may use the HomeNav system to provide “Homeowners Manuals” for new homes, renovations, and remodels, and the HomeNav system can be used to support Green Verified home programs. Realtors may use the HomeNav system to help sell homes by showcasing the features of the home and community. Insurance companies encourage a complete home inventory in HomeNav for back up purposes in case of disaster.

Manufacturers, producers and service providers can use the HomeNav system to build awareness about their offerings to homeowners and industry members with a range of membership, sponsorships, and advertising opportunities. Also, the intuitive design of the HomeNav system allows homeowners to use the system for documenting and tracking the features in their own homes. The HomeNav system uses targeted web links to direct users to manufacturers' web information about each feature.

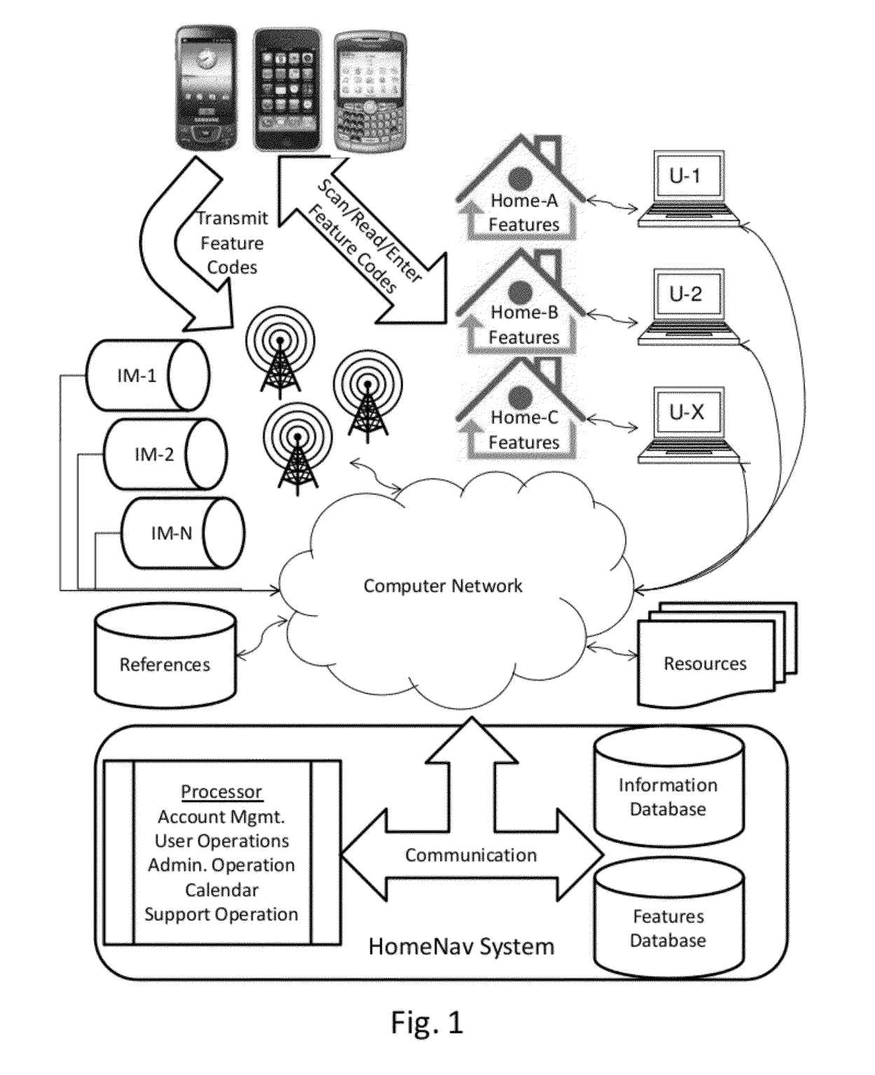

As illustrated by the block diagram in FIG. 1, the HomeNav system uses a centralized database, a centralized computer processor and a centralized communications module to provide the users with an organizational template for an interactive home manual. The centralized database stores datasets with user account information, home locations, home features, information related to the home features, and a set of correlations between the home locations and the home features. The centralized computer processor has an account management module, an interactive user operations module, and an administrative operations module. As discussed in more detail below, the account management module correlates user accounts with the user account information in the centralized database, the user operations module formats the set of correlations for the users' respective accounts, and the administrative operations module manages the database. The centralized communications module is in local communication with the centralized computer processor and the centralized database, and it is in networked communication between the users and the centralized computer processor.

The home locations have a unique address, one or more floor levels, and room selections. The set of correlations identify a room for each of the home features associated with the unique address. The home feature information includes general feature information and user-specific information. Users can access the HomeNav system's database through their networked communication connection and enter their user-specific information into the datasets associated with their home. The administrators of the HomeNav system can vet user-specific information that is entered by the users and transform the information into general feature information that is shared between the users. It will be appreciated that the industry members can also use the HomeNav system and submit information relating to their products and services. The HomeNav system can also provide links to and information from sources that are independent from the industry members. These resources and references can be objective sources of information about the products and services of their industry members.

The home feature information stored in the database can include manufacturer URLs, resource URLs, and reference URLs that direct the users to the corresponding web pages through the networked communication connection. The home feature information can also link to electronic files that are stored centrally in local communication with the computer processor.

The centralized computer processor can also include a calendar module, and the datasets stored in the centralized database include maintenance reminders. The computer processor can also use the information from the database to perform other support operations. For example, the computer processor can be used to populate a seller's disclosure statement for a real estate sale with information from the database. Additionally, the computer processor can work with the database to update the information on furnishings and appliances that are transferred from one home location to another home location. Assigned personal accounts can be removed from any given property record, and that record can be re-assigned to another personal account.

The HomeNav system can have different levels of membership for various users, including homeowners, industry members and resource providers. Once registered in the HomeNav system, users can manage their member account information, such as their name, address, phone, email, billing information, etc. and create and manage one or more properties. The property information includes the physical address, preferably with the county, square footage by floor, the number of stories as well as a finished basement if applicable, total rooms, bedrooms, baths, the direction that the front faces, utility provider information, emergency information, contractor information, service provider information. Attachments/links can be added to the utilities, emergency contacts and contractors tabs in the property details. These items will function more like equipment, in that multiple links and attachments can be included in each. The system can allow users to upload video files which may be used as attachments.

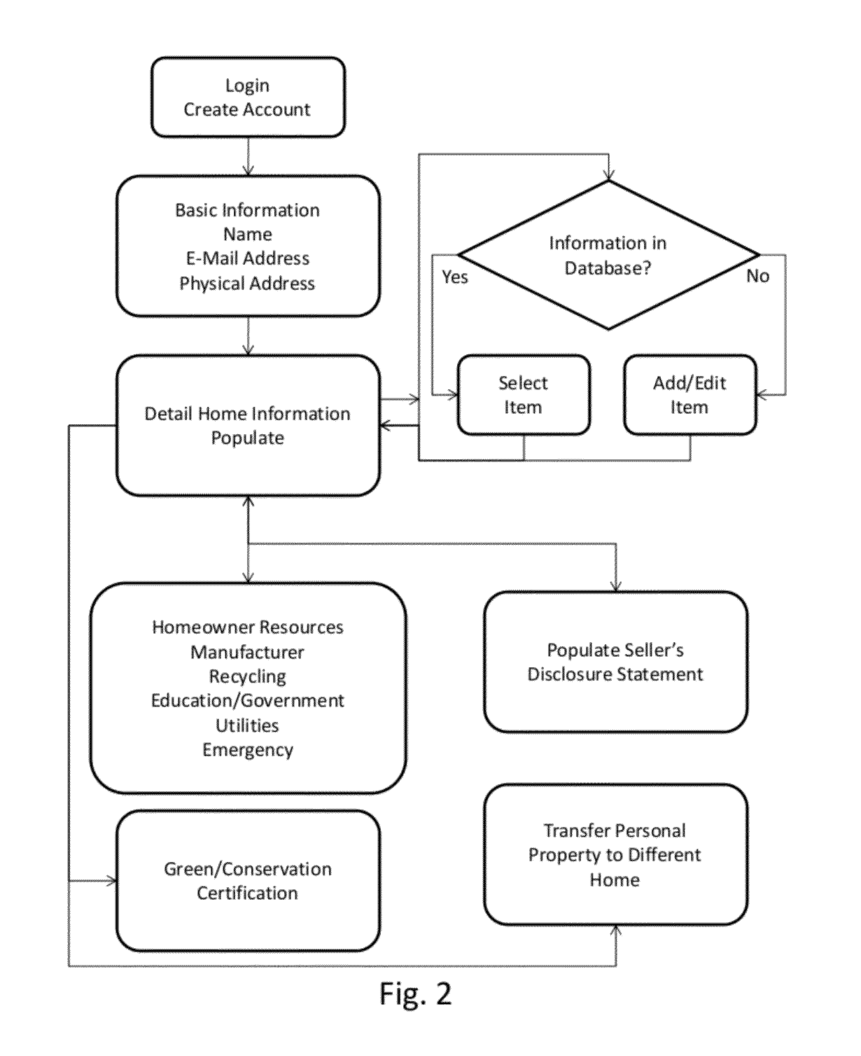

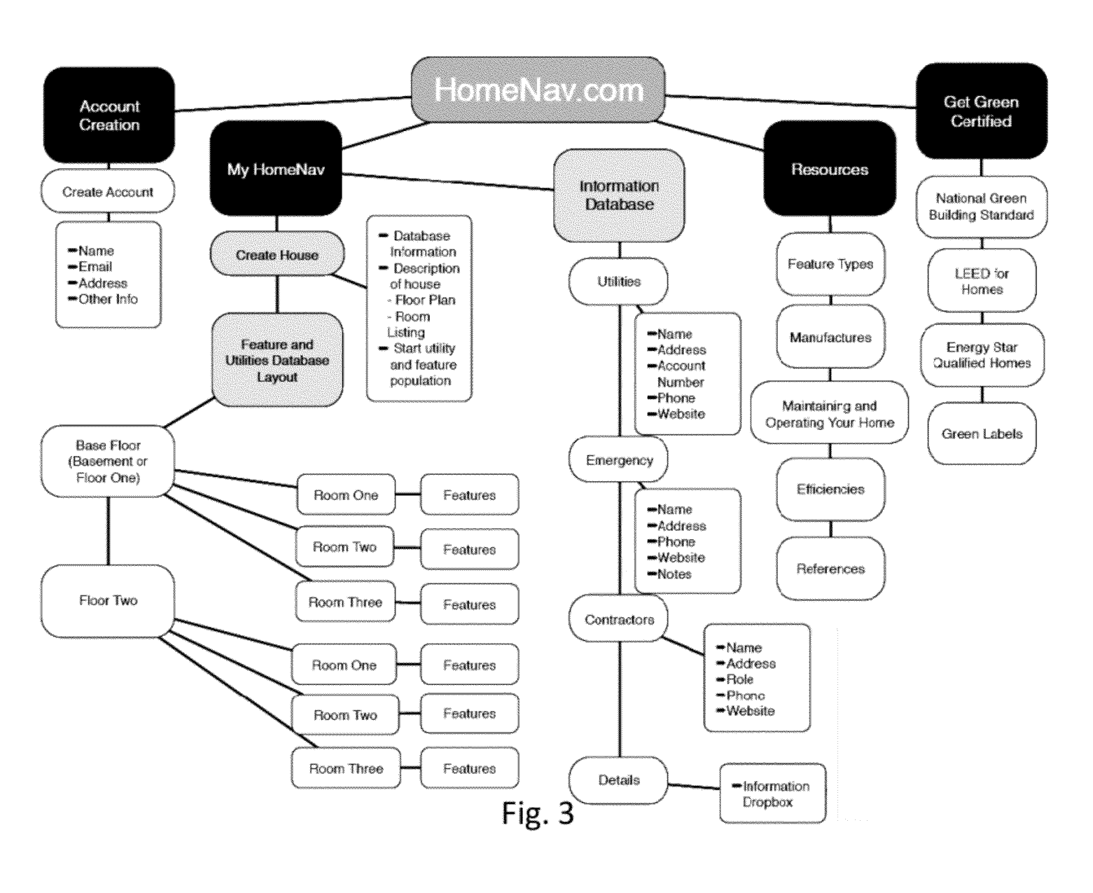

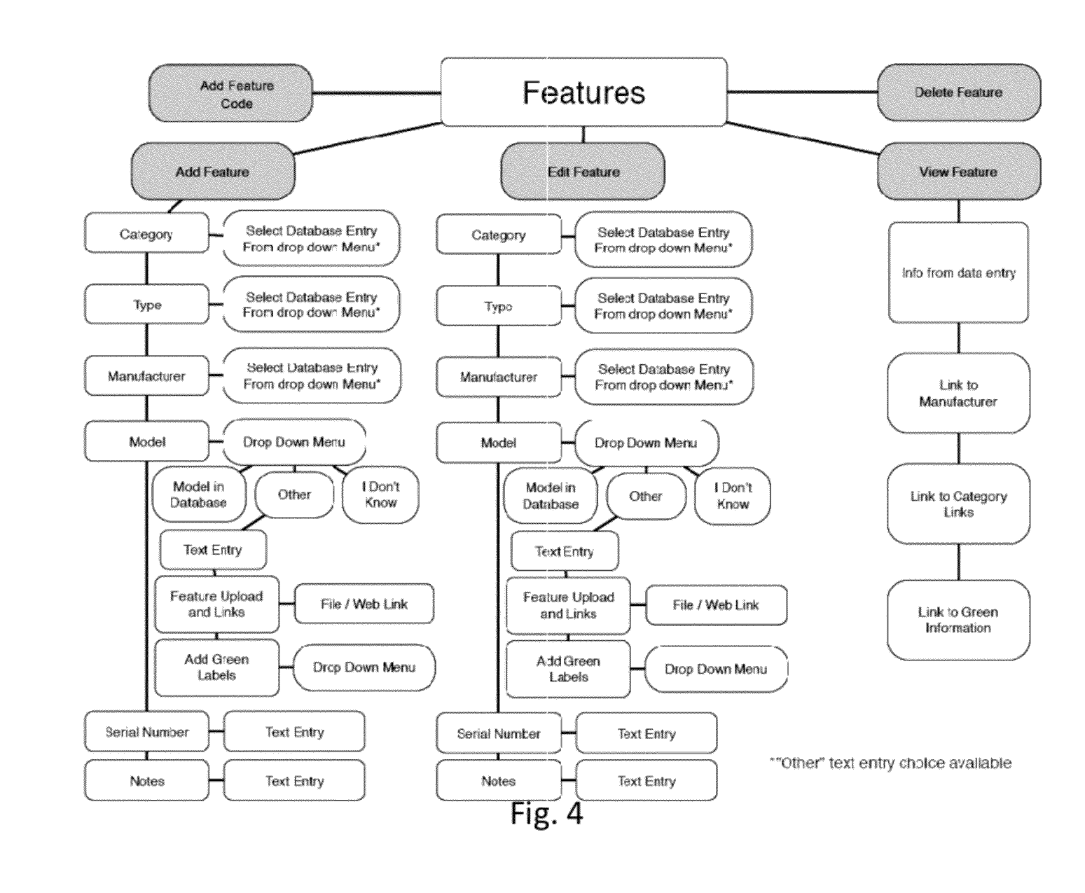

The HomeNav system is intuitive for homeowner users who can create and manage home profile on a room by room basis so that they can virtually replicate the features in their homes. The general process of the HomeNav system is illustrated by the flow chart in FIG. 2, and details of the system's template structure and features are illustrated in FIGS. 3 and 4, respectively. The user adds rooms and can uniquely name the rooms by entering their own individualized titles for the rooms. The system can also provide static drop-down room options that the user can select. Certain information may be pre-populated by the system. For example, the home entry screen may be pre-populated with default floors including “basement,” “floor 1” and “exterior. The system can also indicate whether certain product types are intended for use in the interior of a home, on the exterior of a home or both. When information is being entered by room, by type, by model, the information can be assigned to other. For example, a user can choose kitchen as a room and then add “model” paint color “blue” (to kitchen) and can also select other rooms to add the same paint color.

The system preferably provides the user with drop down lists to make selections although some data may be entered manually. For example, a user may select a “dishwasher” feature from a list of appliances, and the system displays a dropdown listing of dishwasher manufacturers. At various levels of “drill down” in feature selections, the identification of a feature can allow for manual entries, such as when the user enters a model name, model number, or serial number for a particular feature or when the user enters maintenance or operation information related to the feature, such as a local service provider for maintenance or repairs or supplier information for consumable parts and replacement parts. Also, in those instances where information for a feature is not pre-populated in or otherwise available to the system's database, the user may select “other” from list and manually enter data for the feature. Selecting “I don't know” from the list will allow the information about the feature to be only partially complete.

Users can store attachments (computer files of pictures, documents, plans, drawings) and web links to multiple levels of house information. For example, attachments can be saved for the entire home, for particular rooms or floors, and for the various features of the home. Homeowner users can manage multiple homes or properties using the system, and the users can enter and sort information based on category, type, sub-type, brand and room.

It is also possible for the system to allow for automated entries, such as where an industry member includes a code that particularly identifies a feature. The system can be pre-populated with certain information corresponding to the feature that is identified by the code and may also connect with the industry member's system to more particularly define the feature. When the user enters the code into the system, the pre-populated information and/or the information obtained from the industry member's system is correlated with the user's feature. It will be appreciated that the code could be alpha-numeric or graphical (such as a bar code or QR code) and may identify the feature by make, model and even the serial number. The automated entry of the codes into the system may be performed using any device that supports data input technologies (reading, listening or tactile mechanisms), including cameras and other optical scanners, RFID scanners, magnetic strip scanners, microphones with speech recognition tools, keypads, touch-screens, etc. and their corresponding software applications. It will be appreciated that the codes may also be stored in the database and correlated with the features that they define.

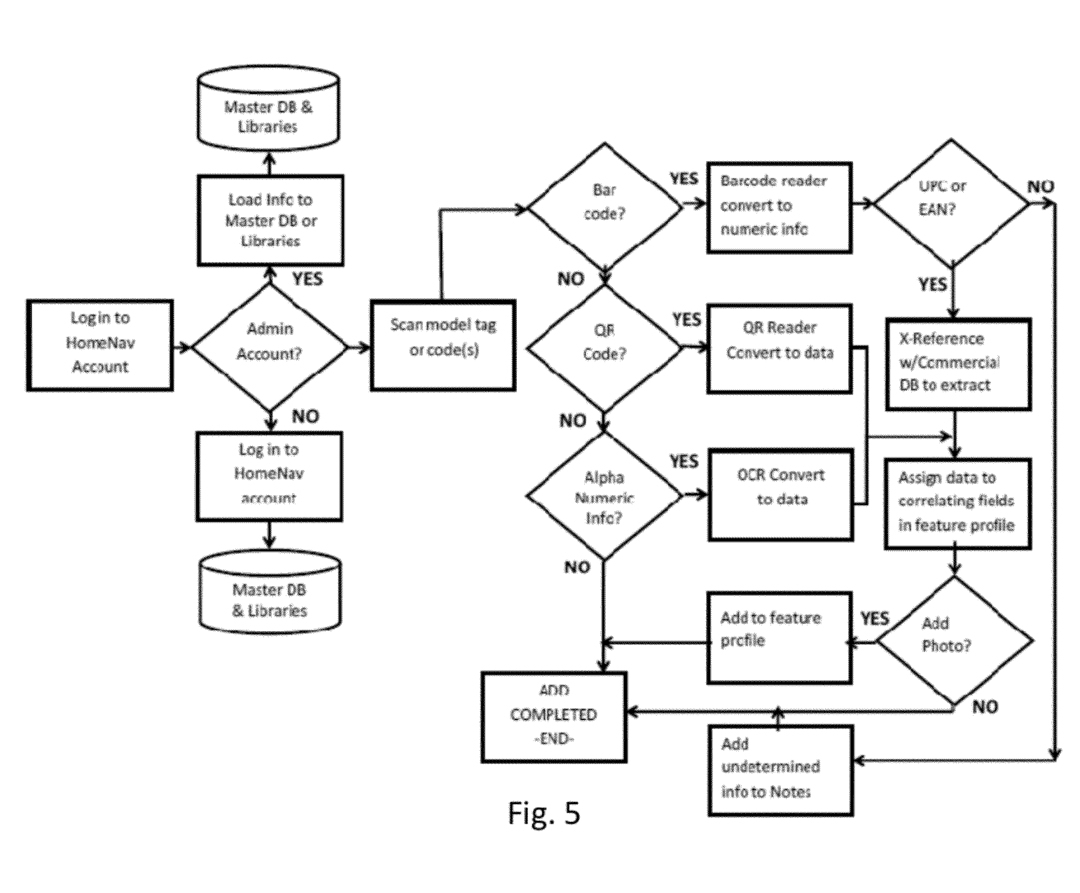

As generally shown in FIG. 1 and particularly shown in the flowchart of FIG. 5, the automated entry option for the codes can be incorporated into mobile communications devices, such as an application for a smart-phone (“smart-phone app”) that has one or more of the data input devices listed above. It will be appreciated that any type of mobile communication device could be used for entering the information, including a smart-phone, a tablet computer or any other mobile internet device. The smart-phone app for the HomeNav system is another advancement that permits users to enter information about their home features with a simple tool. The quick entry tool will work for any component that has a model/serial number tag, bar code or other graphical or numerical code. Most major systems (HVAC, water heater, etc.) and appliances have a tag on them that can be scanned, read or otherwise automatically entered through one or more of the input devices of the mobile communications device. Even when there is no tag or particular code, a user may be able to enter the brand and model information, such as through the keypad, touch-screen or even speech recognition, and the system can search its database records for potential matches. For new purchases, the code on the packaging may be scanned.

The smart-phone app will combine available existing technologies coupled with a custom input program to populate the user's HomeNav web account. The primary existing technologies that are expected to be most beneficial for automated data entries of the home feature codes are OCR readers (such as used in ScanCard, a business card scanning smart phone app) and bar code and QR code readers (such as ScanLife, Google Shopper and QR Reader).

It is envisioned that a user can scan the tag or code with the HomeNav smart phone entry app and the app does the rest. The app automatically scans the information and processes it according to the input. For alphanumerical information, an OCR scanner reads the information and processes it for input to the appropriate fields in HomeNav—make, model and serial number. Any additional information available from the scan will be placed in a notes field. For bar codes, QR codes or other applicable graphical codes, the appropriate scanner on the smart phone will be used to read and process the information. The app will then input the information into the appropriate fields in the HomeNav master database or user account. Photographs may also be uploaded from a smartphone and connected to the home component profile in the user's account, database or library (depending on the user).

The app will combine scanning of text, codes and graphical codes through the use of OCR technology and code scanning technology. Once the codes are digitized, the app will interpret the information (make/model/serial number) and transmit each piece of information to the appropriate field in the master HomeNav database or individual user account. Ability to upload directly to the database or libraries will be limited to administrative users. Account login is preferably required to use the scanner so that correct upload may be accomplished. Once the information is uploaded to the correct fields, it will be available for the user to view and use in completing the profile for a home component.

Should the app determine a code is UPC or EAN, it will interpret the code and then “consult” with a commercial database of UPC and EAN codes to extract additional available information about the component. Commercial databases (such as Google Shopper or other proprietary database that may be accessed or licensed) will help identify information about the make/model/serial number of the component from applicable UPC or EAN barcodes. Access to this information will greatly ease the task of entering data manually into HomeNav.

The smart phone app can require a HomeNav account be established via the HomeNav web site. The web app and smart phone app will work together to populate the user's HomeNav account, database or library according to the user type.

The app may also be used to input information contained in undefined barcodes for filling individual fields in the component profile. For instance, the product tag in a dishwasher includes the text “serial #” with the alphanumeric serial number next to it, followed by a bar code of the serial number. While in the entry mode (in HomeNav) for serial number, snap the barcode for serial number and the information is automatically loaded in the field. This method of use does not include the auto-assigning capability of the full app but does allow for quicker and less error-prone method of inputting relevant information. It will be appreciated that the app could communicate a raw, unprocessed form of the scanned code to the HomeNav system in which case the centralized computer processor could transform the scanned code into the format of the home feature code that is stored within the central database or is maintained by commercial databases. It will also be appreciated that the codes could also be entered through the inputs of a standard computer system and its peripheral data input equipment through networked communication or local communication with the HomeNav system, but the mobile communications device simplifies the process.

Once the particular features of a home are identified, additional information about the features can also entered into the system. For example, the value of the feature, the date of purchase, warranty length, and other related items can be stored within the database and correlated to particular features.

The system also allows users to save and print reports with the basic information for their homes, including information for utilities, emergency first-responders, contractors, service providers, as well as detail files and web links that can be selected.

For administration of the system, the system operators can use the administration module to dynamically build drop-down lists of manufacturers, product categories, product types, products and components. The system operators can also manage files and images, preferably as attachments rather than being uploaded through a file/image manager in the content management system, and may attach electronic versions of manuals to the corresponding features. The system operators also use the administration module to define the general URLs that are available in the drop down lists for direct links to manufacturer product sites as well as managing the system users, such as viewing and managing the user data (name, address, phone, email, billing address, etc.) and resetting the user's login and password.

Just as the system links to the websites of industry members and other resources, the system operators can add content to the system's own web pages. The webpage management can use a content management system and certain content can be incorporated as information into the system's database which is then formatted and displayed by the system's computer processor. Accordingly, the system's content pages can include text content, links, images, etc.

Content is preferably managed in default categories, such as homeowner resources and green homes information. Content can be added below the main categories, and can extend for several or sub-levels. The system operators use the administration module to create and manage search engine optimization elements. Users can be directed to pages through contextual links, emails, external linking, etc. The system operators can also add static links to the content hierarchy and navigation.

The system also allows for custom build content pages that are dynamically populated using data stored in the system's database. For example, industry members are listed alphabetically by name in the IM datasets. Using the IM datasets, users are provided a list of the industry members as well as their corresponding links and attachments. Similarly, a custom build content page can be dynamically populated using data from the feature datasets, listing the feature types alphabetically by name and providing users with a list of links and attachments for the various feature types. Other similar pages may be built for other information.

The system operators can also use the administration module to manage a list of “Green Labels” such as Energy Star or Green Seal. The system operators can attach a “Green Label” to qualifying features. Each Green Label association can be quantified with a specific “Feature” value. The users may also attach a “Green Label” to certain qualifying products when building or managing their homes. As indicated above, the users can also add their own file attachments and links to features and home details.

The system operators can use the administration module to store attachments (pictures, documents, plans, drawings), web links and green labels to multiple levels of information in the master database. The attachments can be stored at various levels of detail (models, series, brands, type, sub-type, categories). As an example of a type/sub-type combination, a countertop would be a type of feature and granite would be a sub-type. In the database, brands and types can be linked to each other so that the system only displays those brands that offer specific types that are selected. For example, when selecting a dishwasher, only the brands that offer dishwashers would display in the select choices.

In addition to personal homeowner accounts, the system allows for commercial accounts for industry member professionals, such as builders, contractors, property managers and real estate agents. With a commercial account, the industry member user can create and manage multiple properties. Along with the ability to manage multiple properties, the commercial account interface allows for efficiently entering information on multiple properties. For example, a commercial account user can make and manage favorites, such as for equipment, as well as home templates. Favorites include a list of equipment brands and models that a commercial account user can save, making subsequent entry easier later. Saved favorites ultimately display at the top of the select list in entry forms, eliminating long and time consuming hunting for brands and models. Commercial account users will have the ability to create and save multiple home templates. These templates can be used as starting points for new homes. Templates operate much like actual home records, but do not include any actual address information. However, each template can include room, equipment and utility information.

Commercial account users can create a personal library of brands and models that may not be included in the HomeNav system's general equipment/features database. This is useful, for example, when a builder regularly uses a local manufacturer for parts or materials—items that would not likely be included in a national database. Items in the commercial user's personal library will also display at the top of select lists in entry forms, below saved favorites.

A commercial account user can enter homes into the system by starting with an existing template. The template can include identical information (rooms, features, etc.) but will exclude any address specific information. The system can be co-branded with these industry member professionals and can provide advertising listings for contractors and service providers, and the commercial account users will be able to assign access to a personal homeowner account, such as when a builder sells a new home to a homeowner or when a new tenant takes possession of a home from a property manager. Assignments of accounts can be made by “invitation” through the system's property record. To formalize and facilitate the relationship between commercial users and personal users, an account transfer model is used. This allows, for example, developers and real estate agents to transfer sole ownership of the HomeNav property profile to a personal user (their customer). Commercial users may also retain a historical record of all transferred properties as snapshot views at the time of the respective transfers and may be notified when their properties are about to expire, offering them the option to transfer the accounts to personal users. For rental properties, the account is accessible by both manager/owner and tenant.

Administrator Operation

1. Getting Started

An administrative operator logs into the HomeNav system with a particular user name and password. The operator selects an administration module (category, type, brand/manufacturer, model, green labels).

Understanding Categories, Types, Brands, Series and Models—categories are the highest level of classification. A category must be chosen first. Next, the type further defines the sub-category and is chosen second. Thirdly, “marry” the type to a brand (aka “manufacturer). Lastly, the “child” or model (or series) results. Whenever information is to be entered into the system or changed, the SAVE tab should be selected to ensure the information is saved by the system.

Category->Type+Brand=Model (or series)

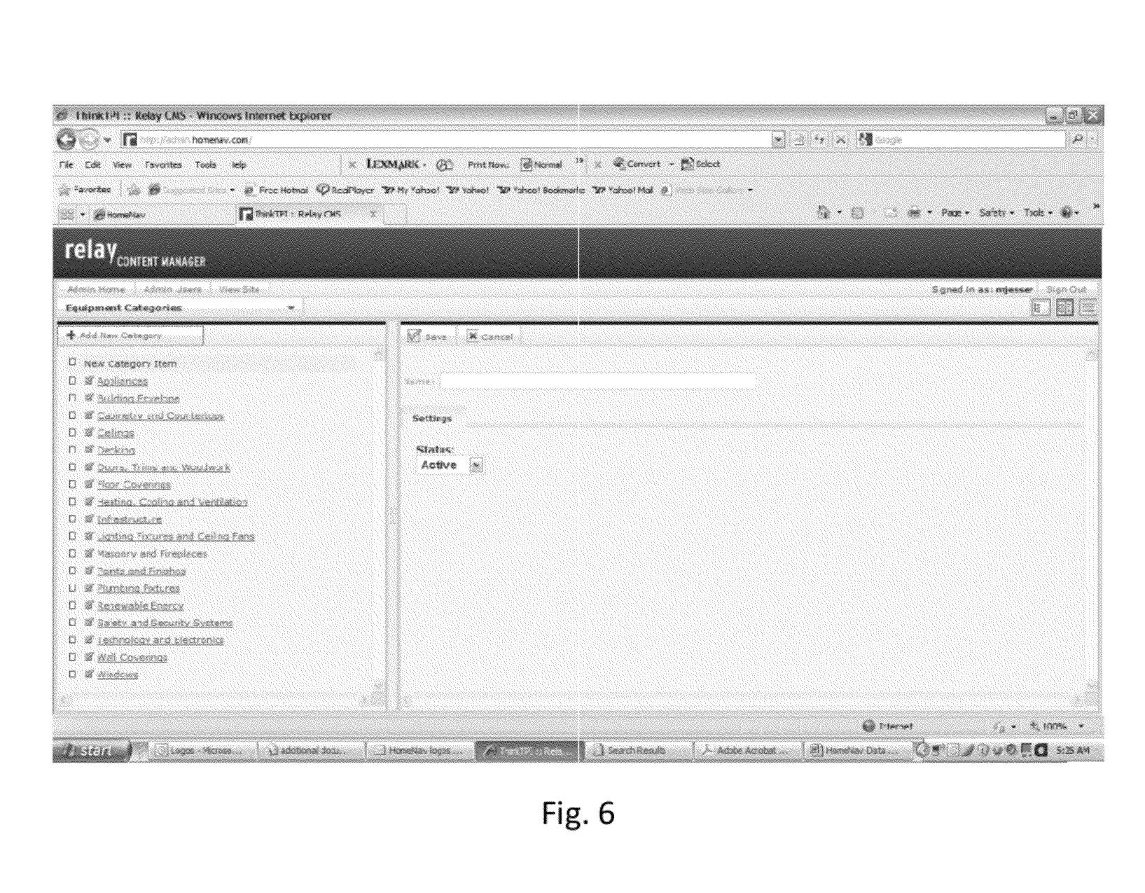

2. Equipment Categories (FIG. 6)

Definition— “Equipment Categories” is a broad list of categories that the components of the home fall under. For example, a smoke detector (Equipment Type) falls under the category Safety and Security (Equipment Category).

Data Entry Process:

To enter an item in “Equipment Categories” click on “Equipment Categories” tab.

To add a new item, click on “Add New Category” and type the new equipment category.

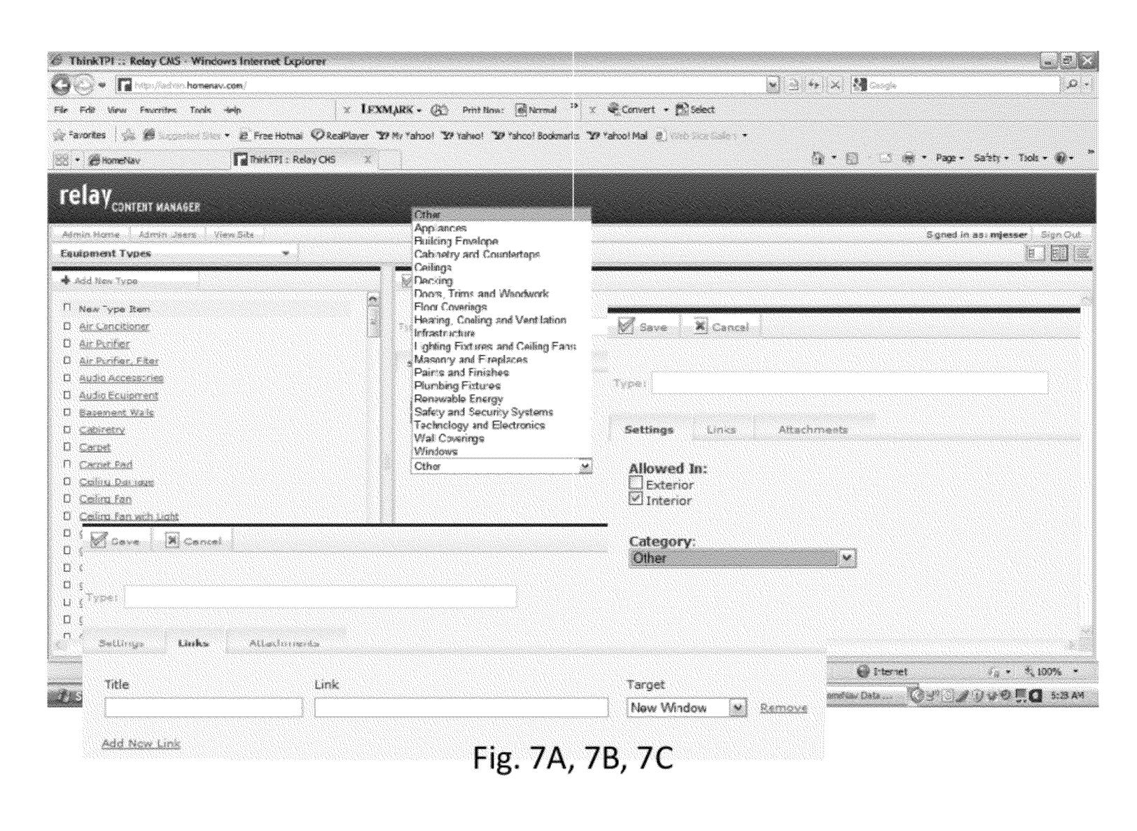

3. Equipment Types (FIGS. 7A, 7B & 7C)

Definition—An item in “Equipment Type” is more specific than Equipment Categories and includes all the components that go into building the home, from the plumbing fixtures to the paint on the walls. For example, carpet would be the TYPE in the category “Floor Coverings”.

Data Entry Process:

When creating new “Equipment Types” that may have several sub-types, enter sub-type, if applicable. When the sub-type field is not available name the “type” with the general descriptor first, then comma, then the descriptive word. For example, a countertop can come in granite, marble, etc. To enter a countertop, enter “Countertops, Granite” (in the Category “Cabinetry and Countertops”). To enter a bathroom sink faucet, enter “Faucets, Bathroom Sink” (in the Category “Plumbing Fixtures”.)

To enter an item in “Equipment Type”, click on the tab labeled “Equipment Type” and then click on the “Add New Type” tab.

Type the new type into the text bar labeled “type”.

Make sure to specify if the item is used in the exterior or interior of the home.

Then choose the appropriate category. Choose “other” if the category is not listed.

For web site links for TYPE look for Third Party web sites that discuss generalities of a product type (please do NOT include any information from a manufacturer's web site—that should go on the respective manufacturer brand page).

Type of information we are looking for to include:
maintaining and operating/cleaning
repair
special attributes—energy efficiency, water efficiency, promotes indoor health, etc.

HOW to Choose a New or Replacement

Each TYPE preferably includes at least one (1) link and no more than five (5) links. If more than 5 sites are located, choose the 5 that offer the broadest range of information.

### Good Places to Start:

Energy Star (www.energystar.gov/index.cfm?c=products.pr_find_es_products)
DOE—Home Energy Basics (www.eere.energy.gov/basics/buildings/)
EPA Watersense Products (www.epa.gov/WaterSense/products/index.html)
eHow (www.ehow.com)
How Stuff Works (www.howstuffworks.com)
Consumer Reports (www.consumerreports.org/cro/index.htm)
Greener Choices from Consumer Reports, includes some helpful buying guides (www.greenerchoices.org/pcategories.cfm?pcat=appliances)
NAHB Toolbase (www.toolbase.org/)
Home Tips (www.hometips.com)

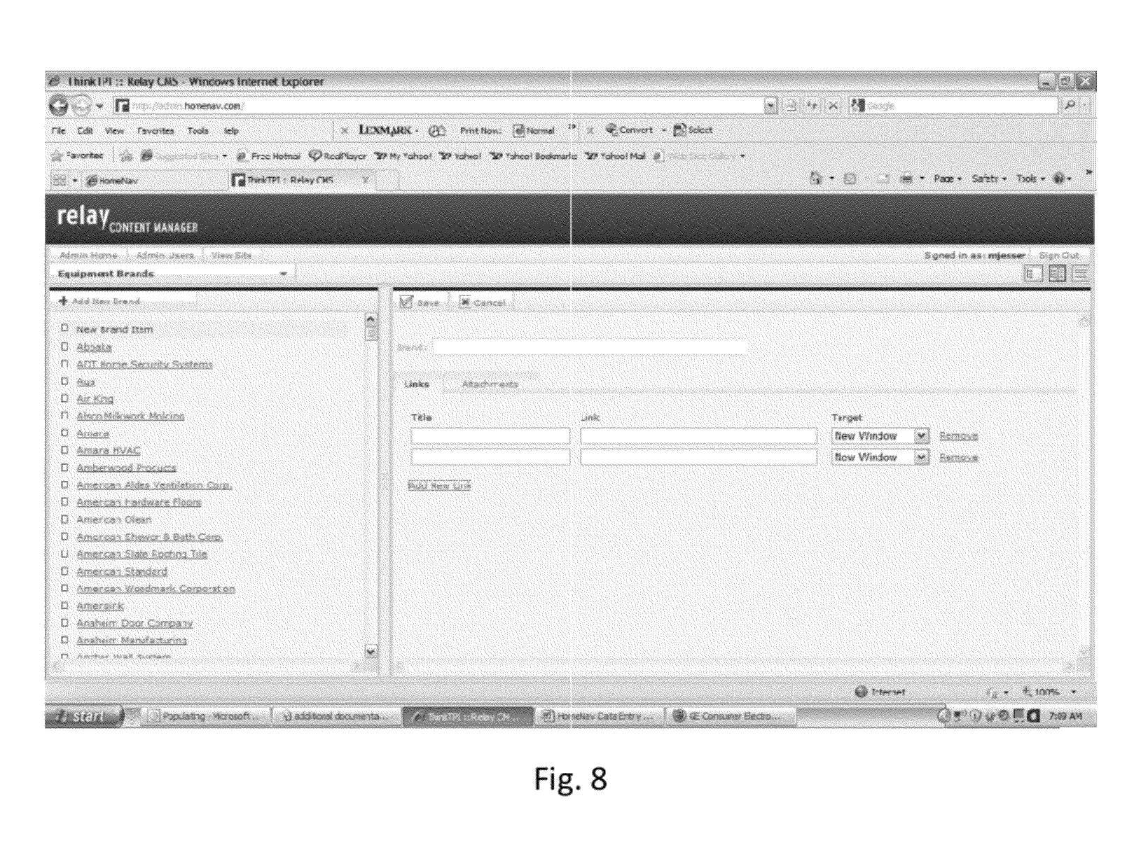

4. Equipment Brands (FIG. 8)

Definition—Any company or manufacturer that sells or manufactures a product.

Data Entry Process:

Click on the “Equipment Brands” tab. Once in Equipment Brands, click on the “Add New Brand” tab and type the brand name in the text box labeled “Brand”.

Add the company's main website under “Links” and “Title”. Under “Title” put the company's name. For example, Home Depot. For Manufacturers who pay to become Showcase Partners (advertisers), companies may be permitted to submit multiple web pages for their brand(s).

For some large companies that manufacture products in multiple industries, it may be necessary to locate the appropriate “main page”. For instance, GE (www.GE.com) manufactures products in a multitude of areas including Aviation and Finance, which do not fit in HomeNav. By visiting www.GE.com, there is a products and services link which offers 2 items of relevance—Appliances and Consumer Products. Further investigation proves that “Appliances” (http://www.geappliances.com/) is the “company main page” we seek. GE Consumer Electronics may also be a viable choice, but further investigation shows it is small electronics and digital devices, not the choice we need for HomeNav. Before adding a web link or other information to the general database available to the users, the HomeNav administrators investigate the information to ensure that it is satisfactory.

Now that the “main page” is located, go to company's “Site Map” or web navigation and look for any or all of the following pages to include as links in the Brand page on HomeNav (some may not be included on company site but rather on the individual model—which will be addressed further on):
Warranty
Owners Manuals
Maintenance and Operation
Care
Contact Us
Customer Service
FAQs
Green or Sustainability or Energy Efficiency or Environmental (everyone calls it something different)
Discontinued Models

IF the company offers a Warranty web page for their entire line, include this page in the links under “Brand”. The title should be “company name” Warranty Information.

IF the company offers a Discontinued Models web page, include this page in the links under “Brand.” The title should be “company name” Discontinued Models.

Again, no more than five (5) links for each brand, so prioritization may be necessary if more than 5 links are located. Oftentimes one page, such as “Customer Service” may include easy to access links to several others such as “Warranty”, “FAQs” and “Contact Us” and can be used in lieu of three (3) separate links.

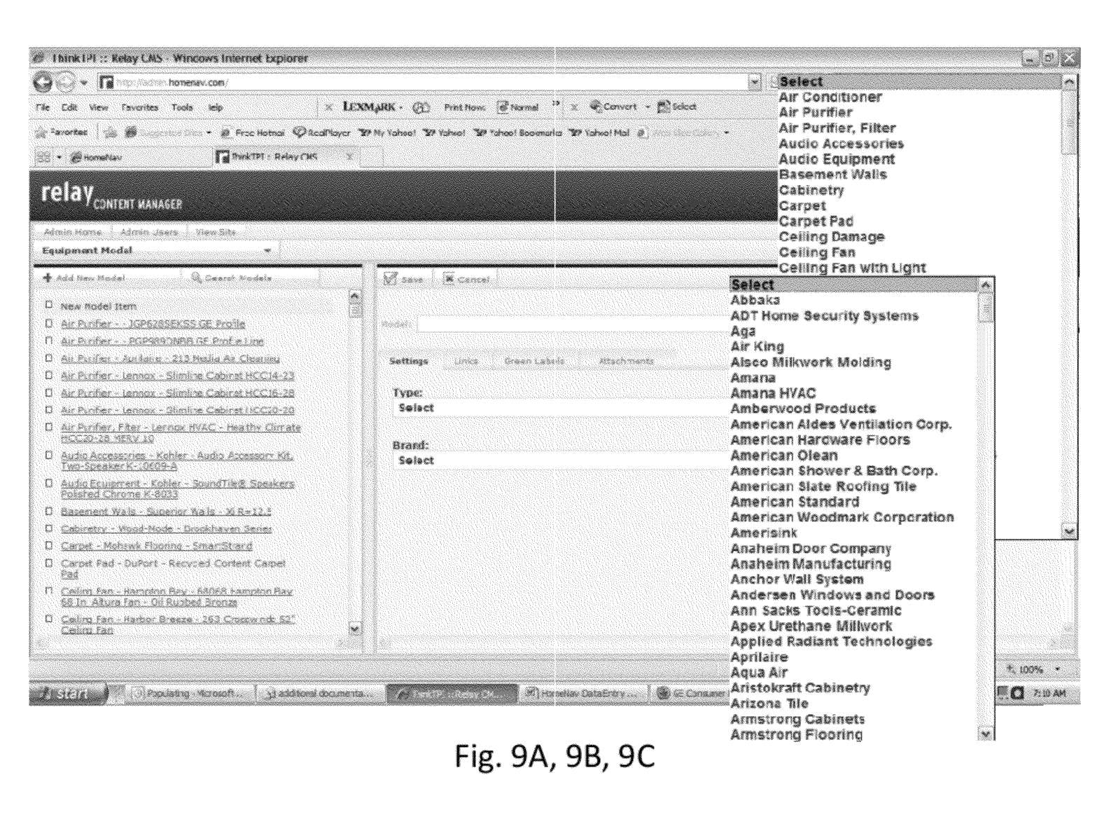

5. Equipment Model (FIGS. 9A, 9B & 9C)

Definition— “Equipment Model” is specific information about a product—a brand and equipment type—and includes the model name and number, the type and the brand.

Data Entry Process:

First, check that the equipment brand exists. If it does not, add the brand and relevant information as outlined in “Add Brand” section above.

Second, check that the equipment type exists. If it does not, add the type and relevant information (or come back to this later) as outlined in “Add Type” section above.

Click on the “Equipment Model” tab. Once in “Equipment Model”, click on “Add New Model” tab and type the model name and number in the text box labeled “Model”. Then select the “Type” of component. Then select the “Brand”.

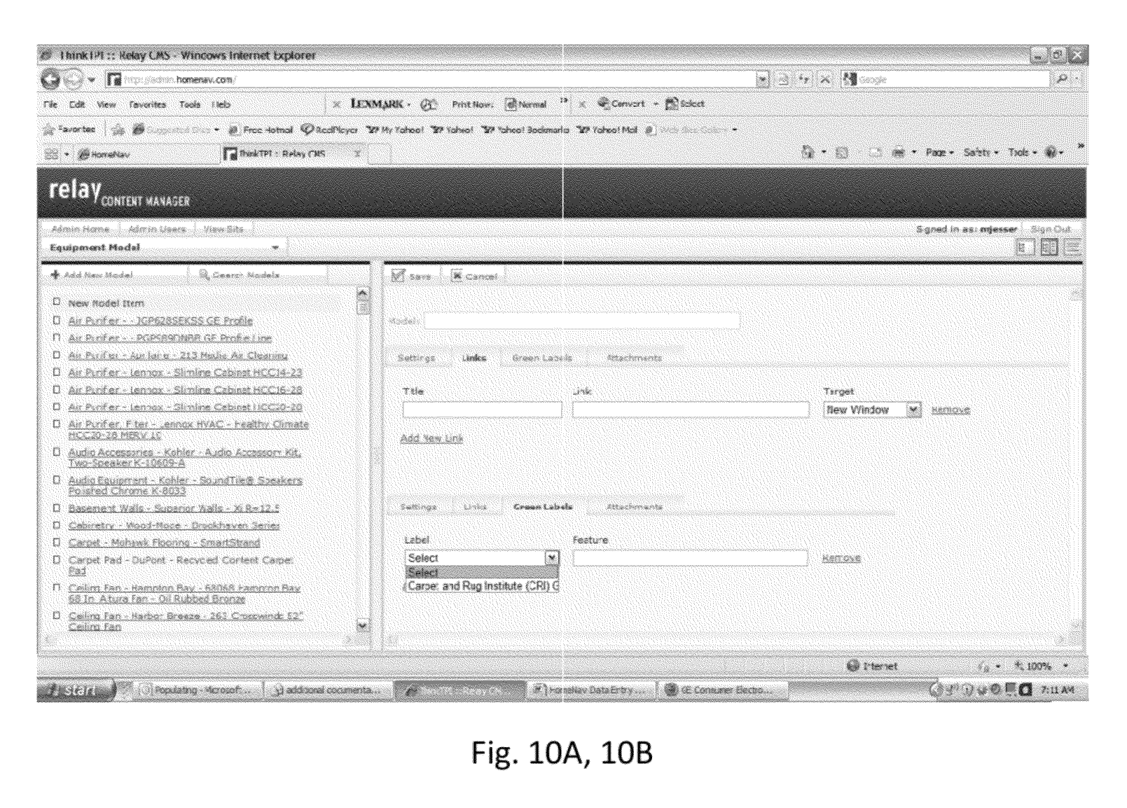

Additional Links for Models (FIGS. 10A & 10B)

There are 2 categories of “models” with different web information to be entered for each:

1. Models from “service contract” homes being input for demonstration and service contracts.

2. Models from “at-large” or general information used to help populate the component database

“Service Contract” Models Links—use the “model page” link from the manufacturers' web site. This page may be located by searching for the Model name/number (i.e. with Google Search) or by going to the manufacturers web site and searching (via the manufacturers' web page search tool) or by “drilling” down to the model through the product pages on the manufacturer's web site. Often a model number/name search, once in the manufacturers' web site, will yield good results. If unable to find the complete model number, typically the first 3 to 5 numbers of the model are the “series” number and the remainder of the numbers identify options, features and/or accessories. By locating a “product” or “series” page that corresponds to the first 3-5 numbers in our model number, it will usually provide a good match for the product we are adding to the database. (this may need to be its own bracketed number) For Manufacturers who pay to become Showcase Partners (advertisers), companies may submit their choice of up to 5 web links (pages) and 3 attachment documents (manuals, warranties, care) for each model purchased via their Showcase Agreement. Information may be submitted electronically to the database via an API or other transfer tool.

There are a number of private label items that need to be researched in a different manner. To identify if a product is a private label, do a Search (i.e. Google or Bing) for as much of the name and model number as you have. Survey up to the first 3 pages of search results looking for a manufacturer name along with the product/model name. Several consistent results of a manufacturer name indicate the manufacture. Conduct another search now including the manufacturer name AND the product/model information. This should result in a model or series page from which the model page can be located.

If no results on a search for manufacturer names, look for a big box store name (i.e., Home Depot or Lowe's) along with the product/model name. Several consistent results of a “big box” store name indicate this is a private label product/model. Conduct another search now including the “big box” store name AND the product/model information. This should result in a model or series page (on the “big box” store's web site) from which the model page can be located. While this is not the preferred information, this is often the best available information on the web and usually provides at least the basic product and warranty information.

For instance Harbor Breeze 44″ ceiling fan, through this sequence results in a product page on Lowe's web site http://www.lowes.com/pd_{—}96950-1811-E+BE44AN5C_{—}4294935508+4294965856_{—}4294937087_?productId=1267031&Ns=p_product_prd_lis_ord_nbr|0∥p_product_quantity_sold|1&pl=1&currentURL=%2Fpl_Harbor%2BBreeze_{—}4294935508%2B4294965856_{—}4294937087_%3FNs%3Dp_product_prd_lis_ord_nbr|0∥p_product_quantity_sold|1&facetInfo=Harbor%20Breeze.

“At-Large” Models Links—use the “series page” and/or “model page” link from the manufacturers' web site. This page may be located by searching for the Series and/or Model name (i.e. with Google Search) or by going to the manufacturers web site and “drilling” down to the Series and/or Model page. Often a Series or Model name search once in the manufacturers' web site will yield good results. Remember that a Series or Model link may be used for multiple models in the same Series or Model if that is the case.

Each piece of equipment should include additional information that will be listed under the “Links” tab on the “Add New Model” page.

Examples of the type of info we want to provide: A direct link to the model that includes warranty, spec sheets, maintenance and care for this specific component; Energy or water efficiency tips. Or a link to the Series page that lists all of the Models in the Series (from here, the user may find the appropriate Model and Model page).

Data Entry Process for “Equipment Model” Links

Click on the “Links” tab listed under “Add New Model” page. Enter the title information and the link associated with the information. To add additional links, click on the “Add New Link” link and use the same process as above.

Example of information for additional links: ENERGY STAR Main Website http://www.energystar.gov/

In addition to adding information under “Settings” and “Links” you may need to enter “Green Labels” information. Not all products will have a “Green Label”. For those that do have a green label, select the “Green Labels” tab and select the appropriate certification. You do not need to enter anything under “Feature’.

The resource and green pages process for the HomeNav system is described below

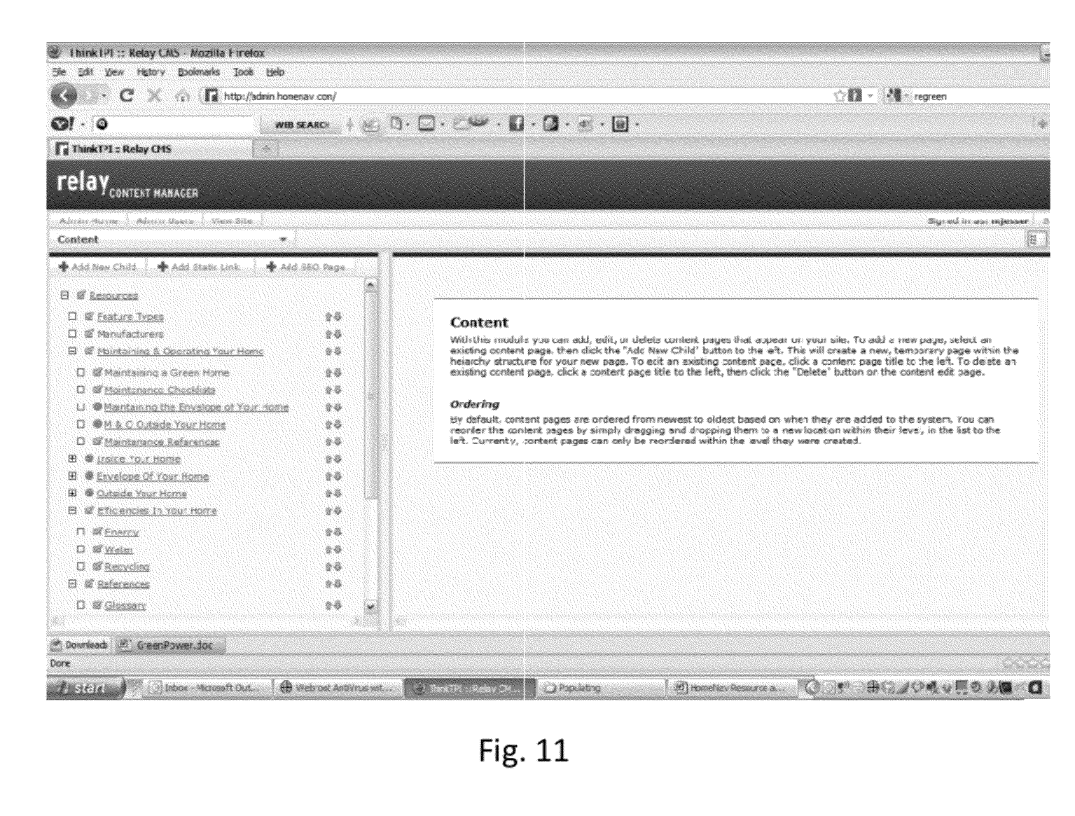

1. Getting Started (FIG. 11)

Go to admin.homenav.com/ and log in with your user name and password.

Choose the Content module (Homeowner Resources, Green Homes, or other modules) and then click on the + next to the section (Resources or Get Green Certified) to work in. The expanded list of pages will appear. Click on the page to work on it in the editor.

2. Resources

Definition— “Resources” is a compilation of information about the many aspects of home ownership. The information in Resources is broadly arranged to provide easy access to a targeted set of web sites (with hyperlinks) for the home owner. EVERY web site listed on HomeNav (resources or in the database) is selected and checked out by a member of the HomeNav team. For each topic or sub-topic, HomeNav targets the top 3 to 5 web sites to provide the best information we can find. The links will change and be updated, as new and better information is located on the web.

Goal—to provide homeowners and members of the building industry easy and fast access to targeted links to provide information for taking care of and improving a home.

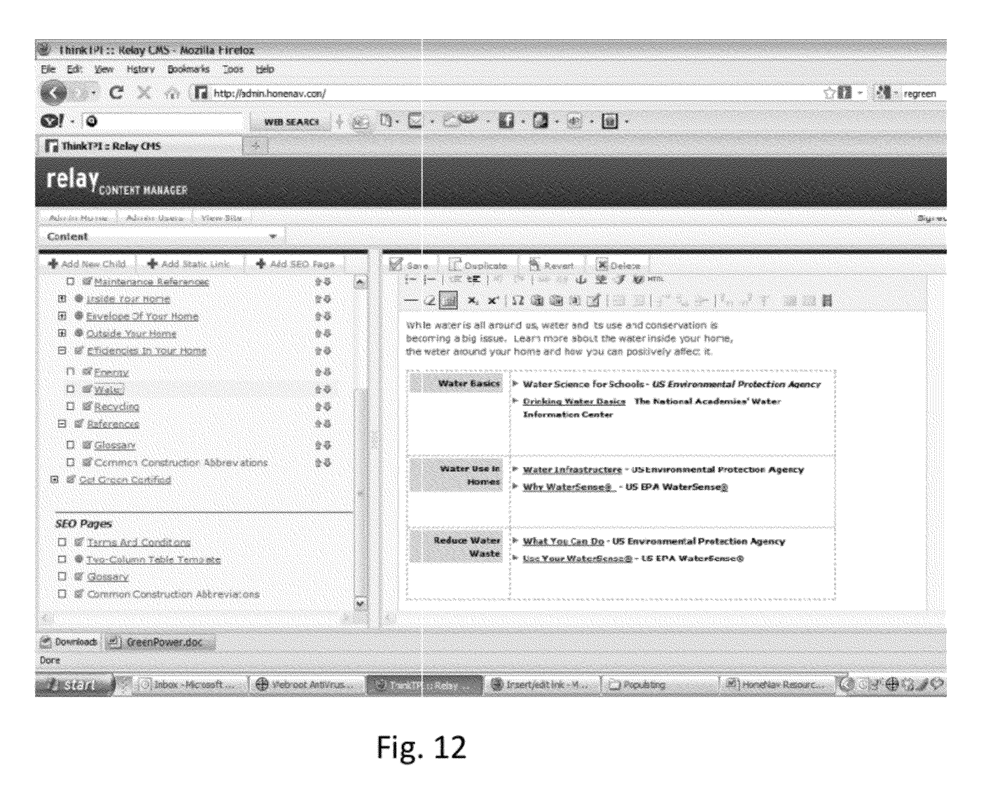

Web Link Research Process (FIG. 12)

Each topic (or sub-topic) discussed in the Homeowner Resources section should have at least three (3) links—one (1) or more (no more than five (5) each) for each topic (or sub-topic):
Basic Introductory Information=“Topic 101”
Problems, Issues and Challenges of the “Topic”
Solutions for the “Topic”

Additional information such as how-to information, care, sustainability factors, etc may be added. Google Searching the topic is often a good tool. Start points can be provided:
Energy Star™™ www.energystar.gov
DOE—Home Energy Basics www.eere.energy.gov/basics/buildings/
EPA Watersense http://www.epa.gov/WaterSense/index.html
eHow www.ehow.com
How Stuff Works www.howstuffworks.com
Consumer Reports http://www.consumerreports.org/cro/index.htm
Greener Choices from Consumer Reports, includes some helpful buying guides http://www.greenerchoices.org/pcategories.cfm?pcat=appliances
NAHB Consumer information http://www.nahb.org
NAHB Toolbase http://www.toolbase.org/
USGBC Green Home Guide http://greenhomeguide.com/
USGBC Regreen http://www.regreenprogram.org/
Green Building Publications sites
Home Tips www.hometips.com or www.HomeTips4Women.com

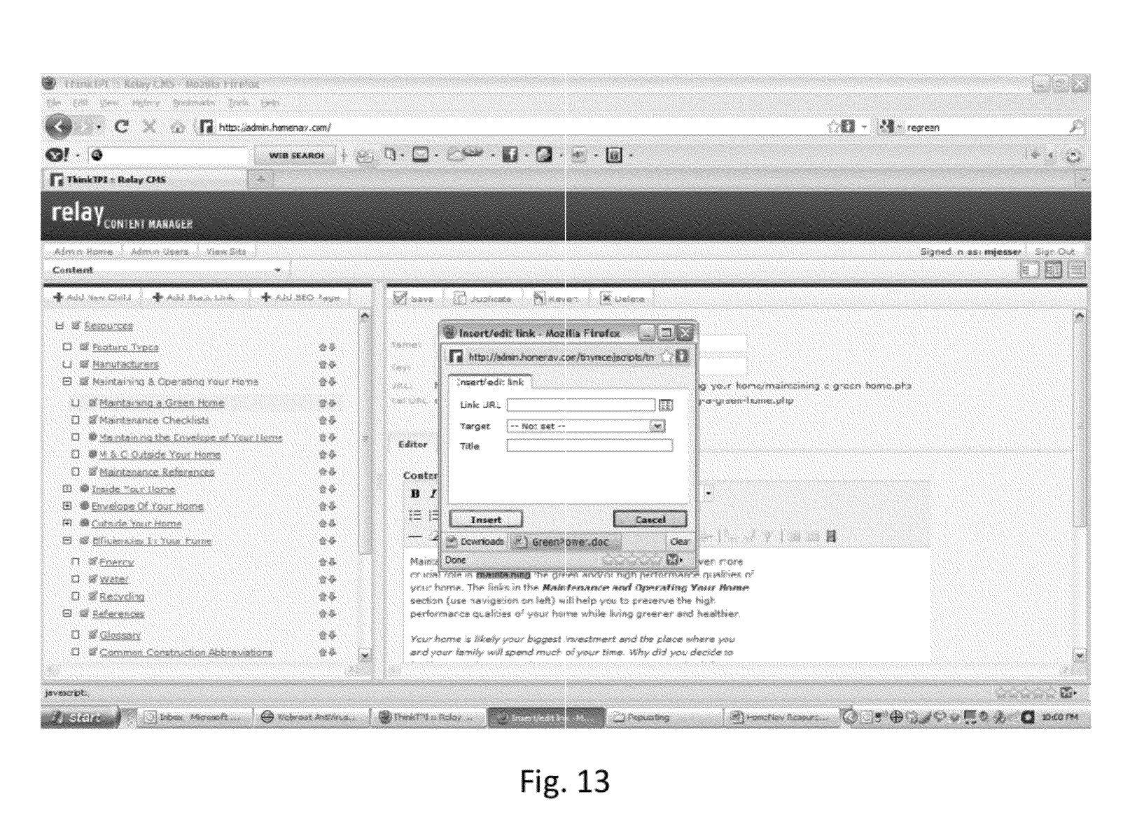

Web Page Creation Process (FIG. 13)
Click on the “parent” page (the one the new page should go under) and click “Add New Child”. Enter the requested information.
Create the page as you would a document in an editor. Brevity is key. Short paragraphs and bulleted lists work best.
To create (or edit) hyperlinked web site references:
   refer to the web site by title (include source),
   highlight the web site title and click the “add link” (looks like chain links) icon. This will open the INSERT/EDIT LINK Window.
   From the actual web page for the item, copy the entire URL and paste it in the LINK URL field.
   For the TARGET field, select “open link in a new window”
   For the TITLE field, enter a shortened version of the web site title
   Click INSERT
To un-link a web reference, click the UNLINK (looks like a broken chain) icon. If need to add a new hyperlink, just follow the instructions for creating the link.

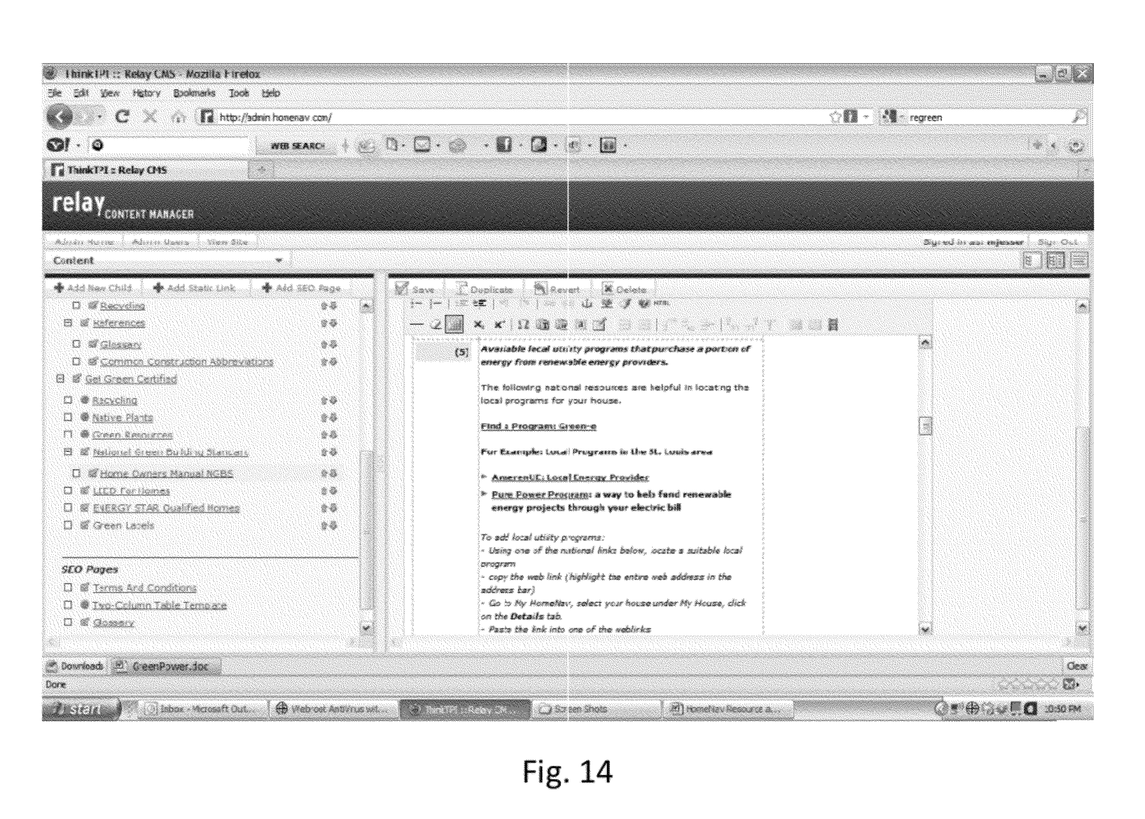

3. Green Homes (FIG. 14).

Green Homes provides resources and information about greening an existing home and/or lifestyle through maintenance, operation, replacement and remodel or building a new or rehabbed green certified home. One section of the Green Homes content module will be “Green Certified Homes” as described below. For any homeowner interested in greening a home, there is information and resources on many aspects of the home, including Maintenance and Operations, Remodeling, Renovation and Replacements of Existing Home Systems. The Green Homes content module can contain checklists and information on green cleaning, green supplies, Energy Star appliances and recycling programs.

Definition— “Get Green Certified” is an introduction to the most common Green Home Certification programs and links to obtain more information on each of the programs. It is also the outline and step-by-step instructions for completing the online, interactive homeowners' manual for two (2) of the programs requiring the homeowners' manual as part of the certification process. The information in the Homeowners' Manual section is presented in the same order as the respective Green Home program for which it meets the requirements. Where feasible, HomeNav provides 2-3 resources and/or references for each topic addressed. EVERY web site listed on HomeNav is selected and checked out by a member of the HomeNav team. The links will change and be updated, as new and better information is located on the web. Much of this information is also provided under the Homeowner Resources section and often links to pages in this section.

Goal of Green Certified Homes—to provide green builders/remodelers and homeowners an easy to use, interactive tool for the homeowners manual information required by the respective Green Home program.

Web Link Research Process

Each topic (or sub-topic) discussed in the Green Certified Homes section should have at least one (1) and usually 2-3 links—for each topic (or sub-topic).

Google Searching the topic is often a good tool. National reference sites that provide local information are needed for several items (i.e. transportation, recycling and local utility programs). Good places to start are listed above.

For topics where including house specific information is required, tailor the following instructions to fit the need called for in the practice.

To include the certificate or completion document:
Go to My HomeNav, select your house under My House and click on the Details tab.
Upload the document using the upload tool.
Enter the title for the document “NGBS1001.1(1) Green Building Program Certificate”

To view the document, go to Details tab in House Overview in My HomeNav.

Web Page Creation Process:
Click on the “parent” page (the one the new page should go under) and click “Add New Child”. Enter the requested information.
Create the page as you would a document in an editor. Brevity is key. Short paragraphs and bulleted lists work best.
To create (or edit) hyperlinked web site references:
   refer to the web site by title (include source),
   highlight the web site title and click the “add link” (looks like chain links) icon. This will open the INSERT/EDIT LINK Window.
   From the actual web page for the item, copy the entire URL and paste it in the LINK URL field.
   For the TARGET field, select “open link in a new window”
   For the TITLE field, enter a shortened version of the web site title
   Click INSERT
To un-link a web reference, click the UNLINK (looks like a broken chain) icon. If need to add a new hyperlink, just follow the instructions for creating the link.

User Operation

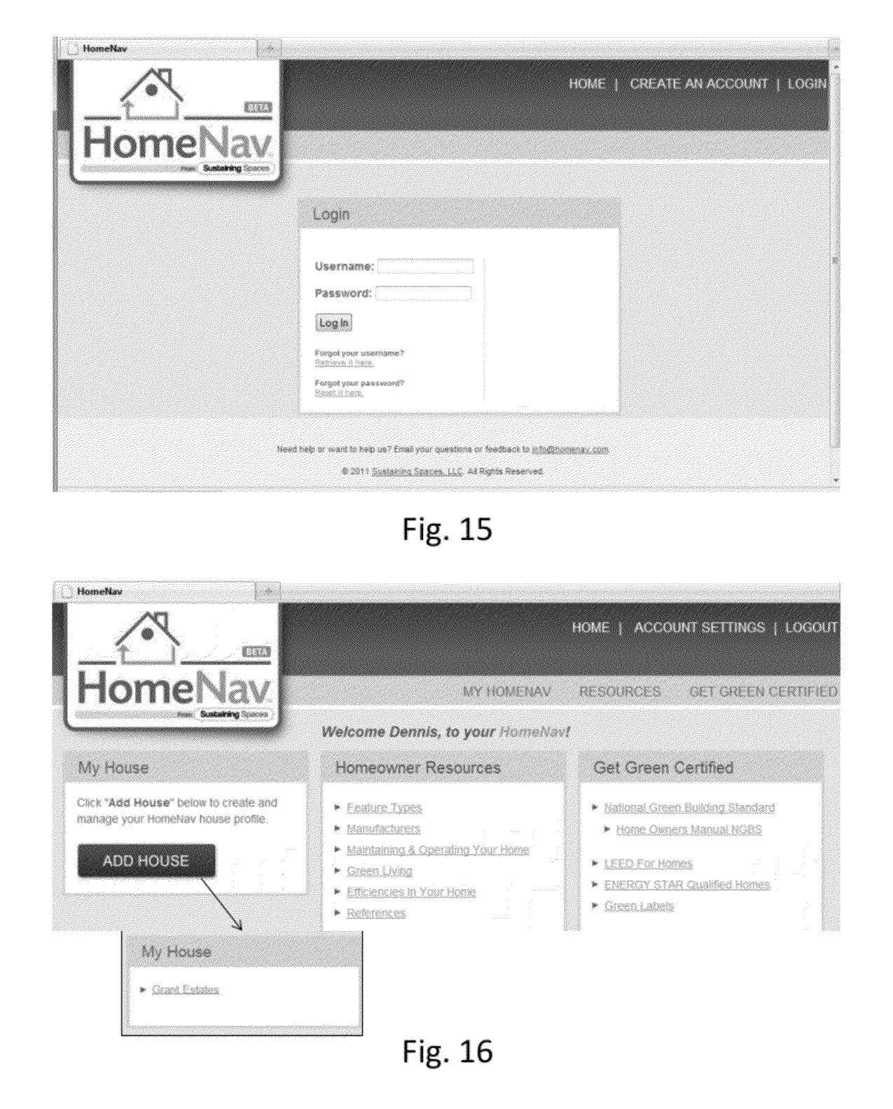

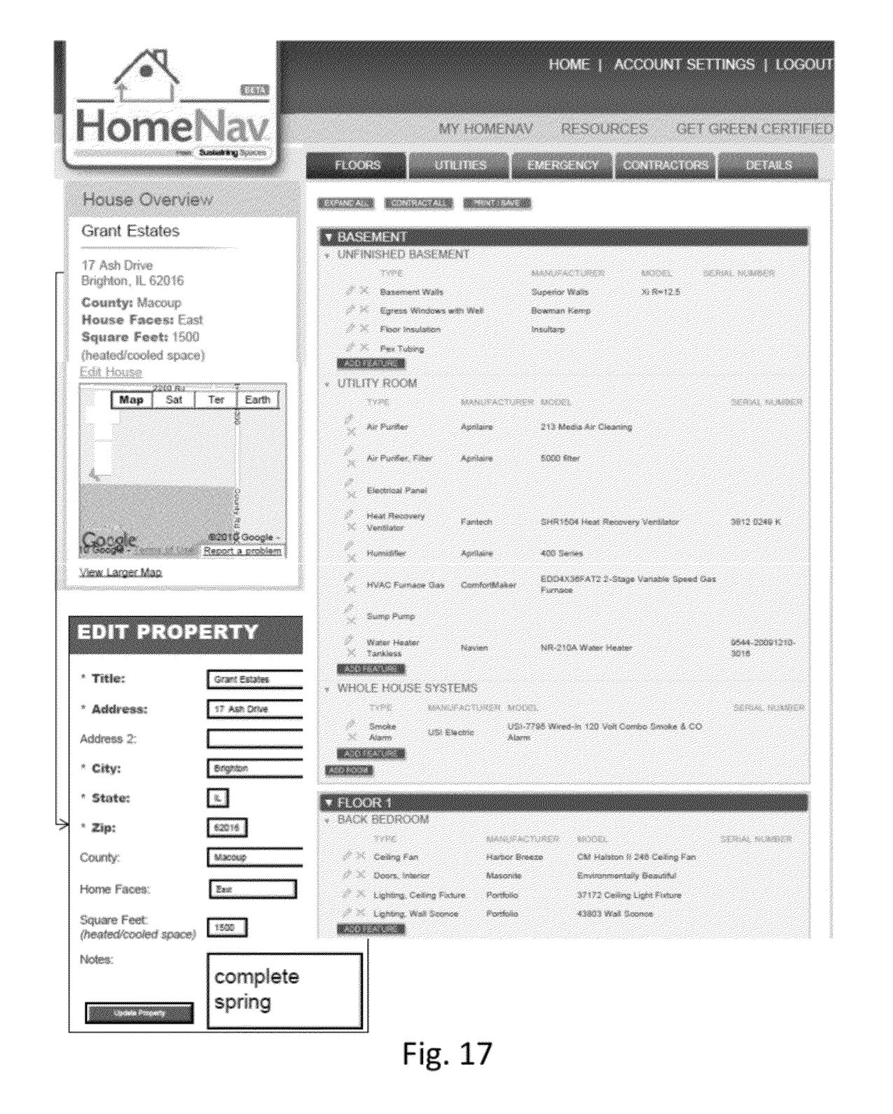

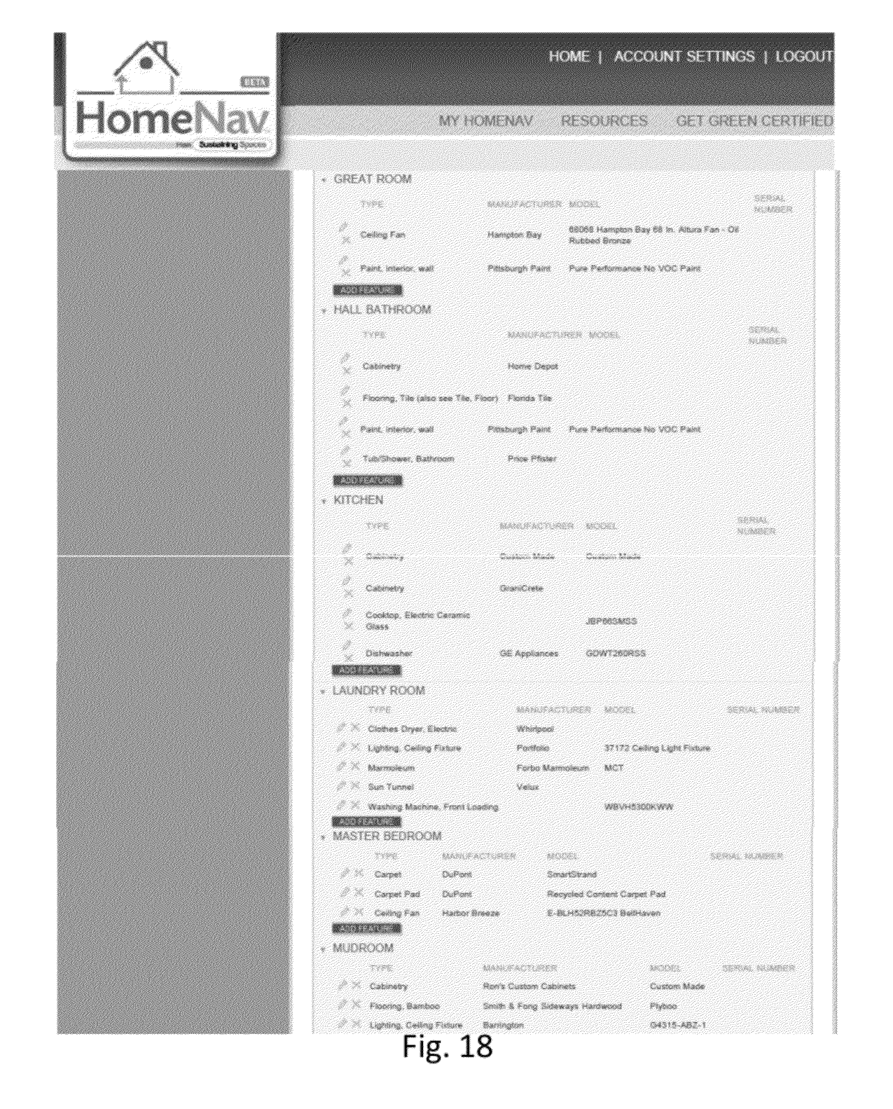

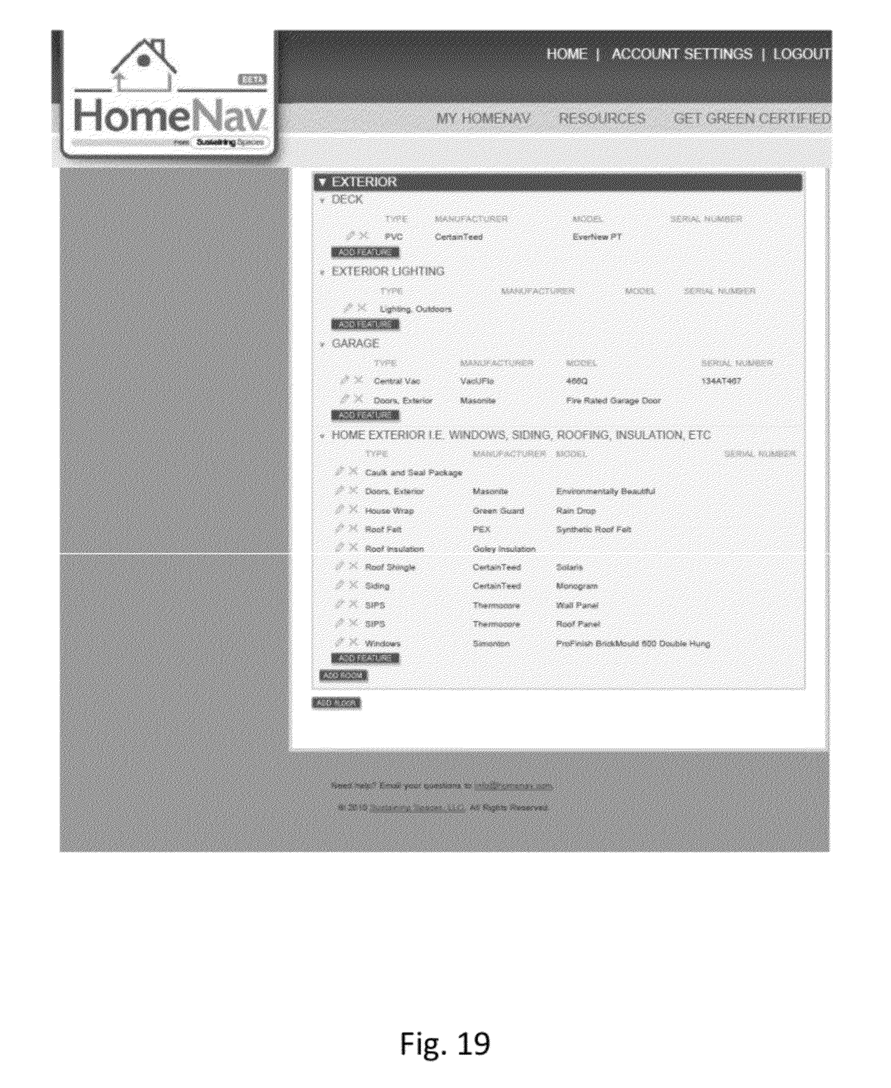

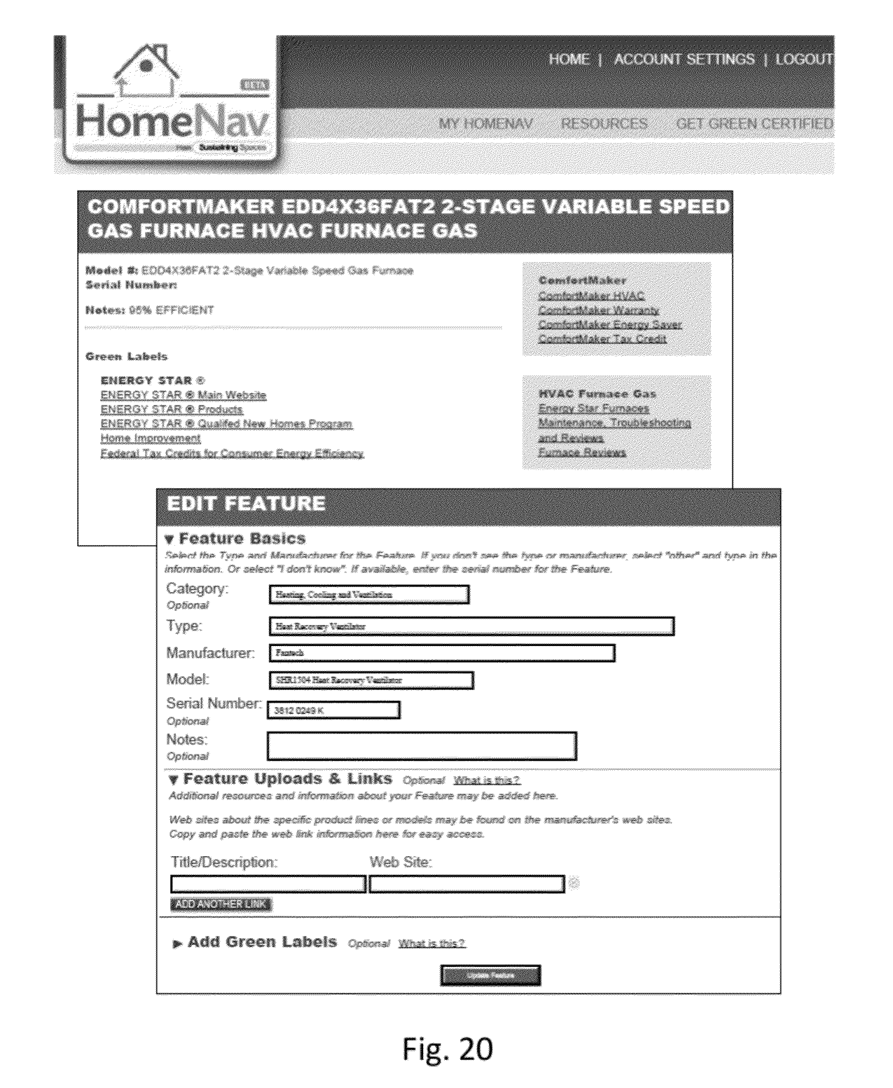

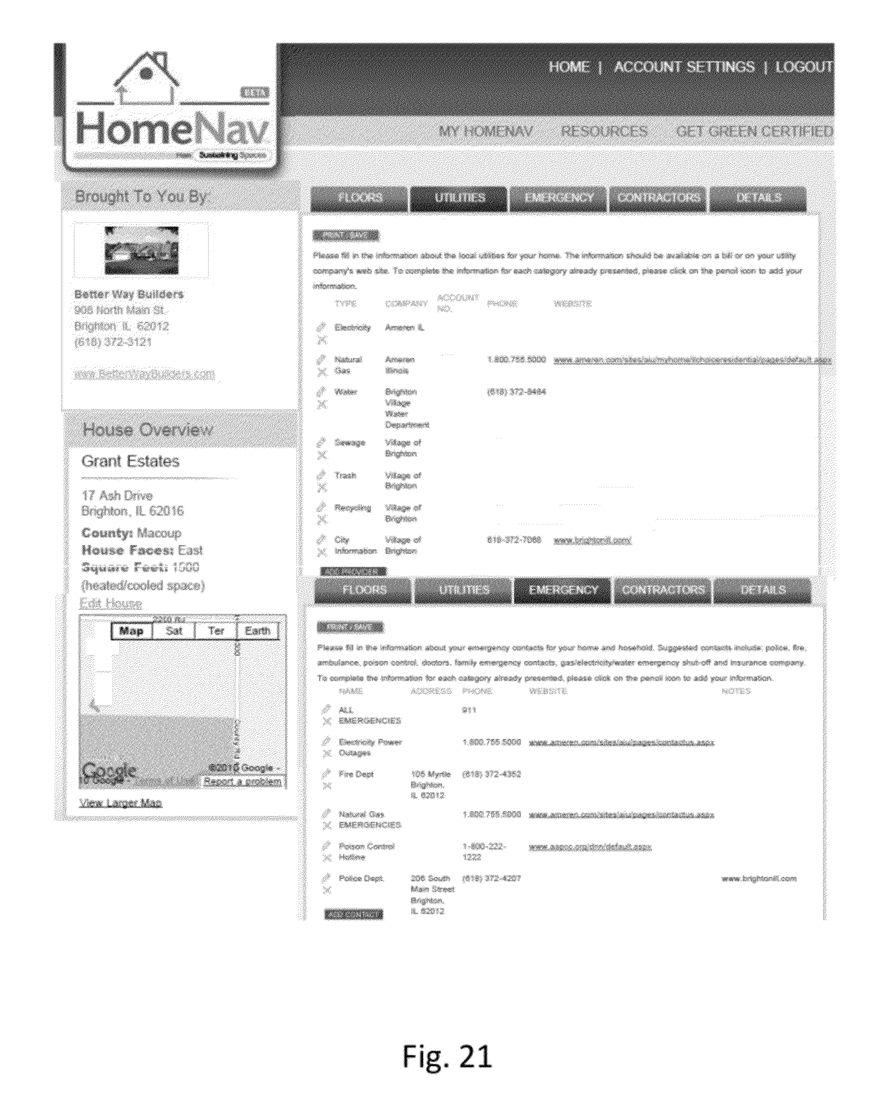

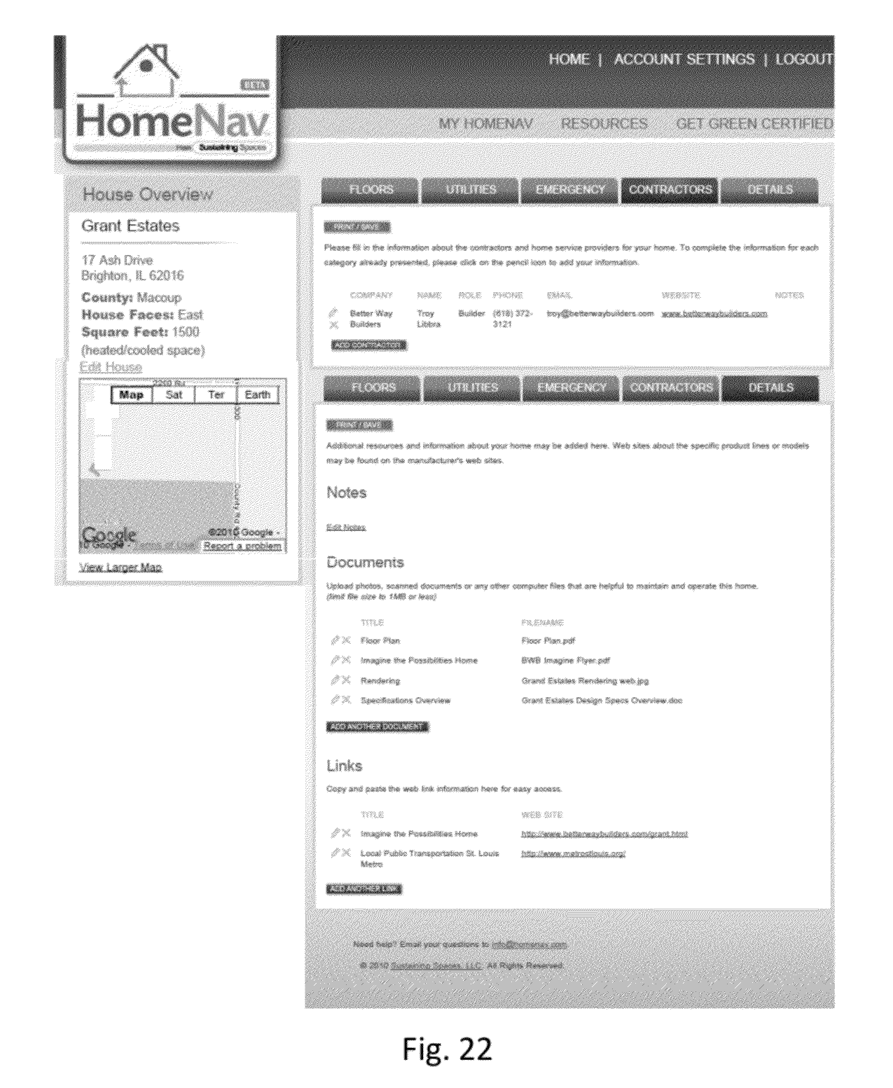

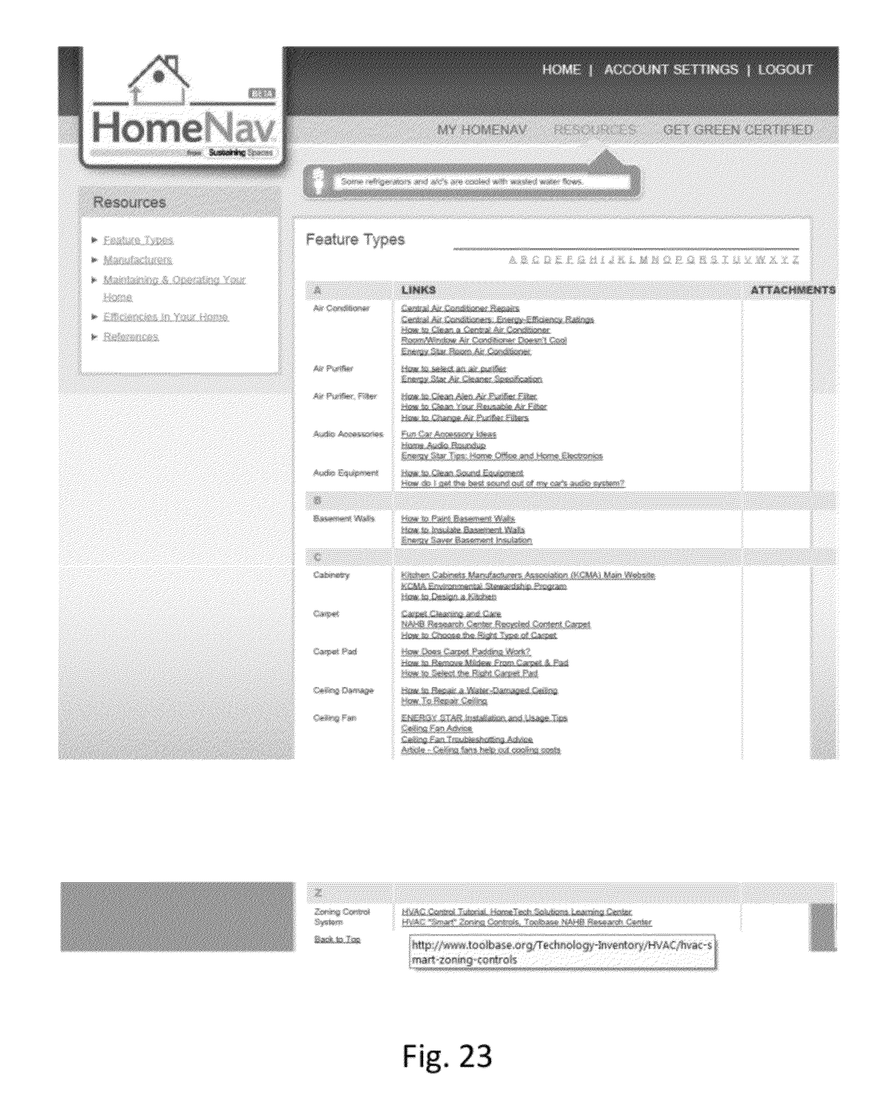

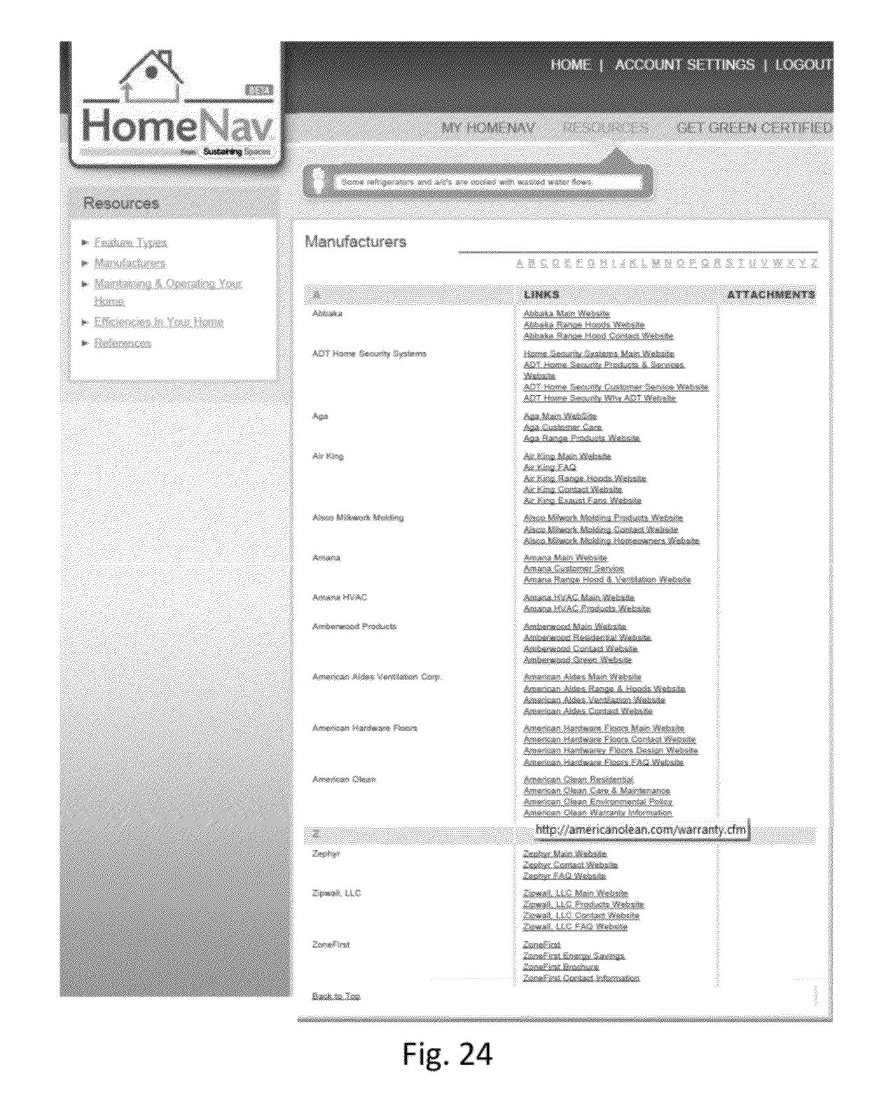

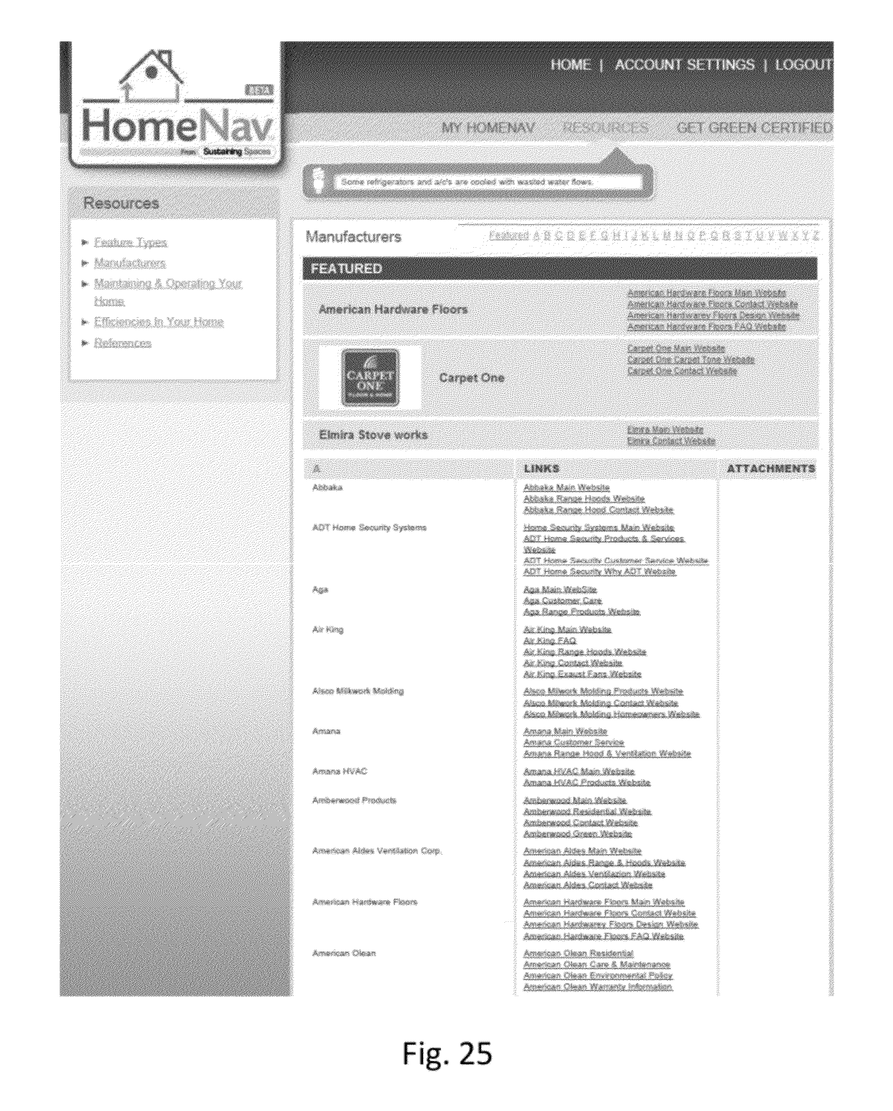

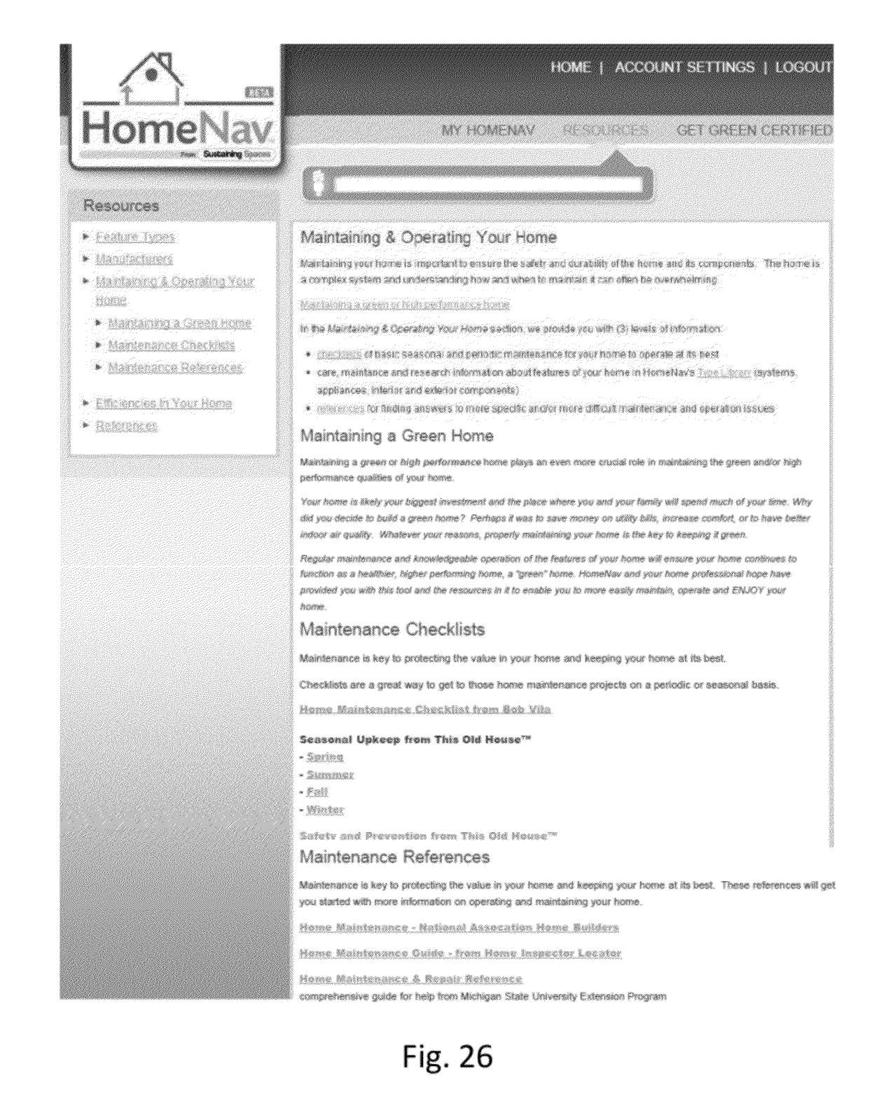

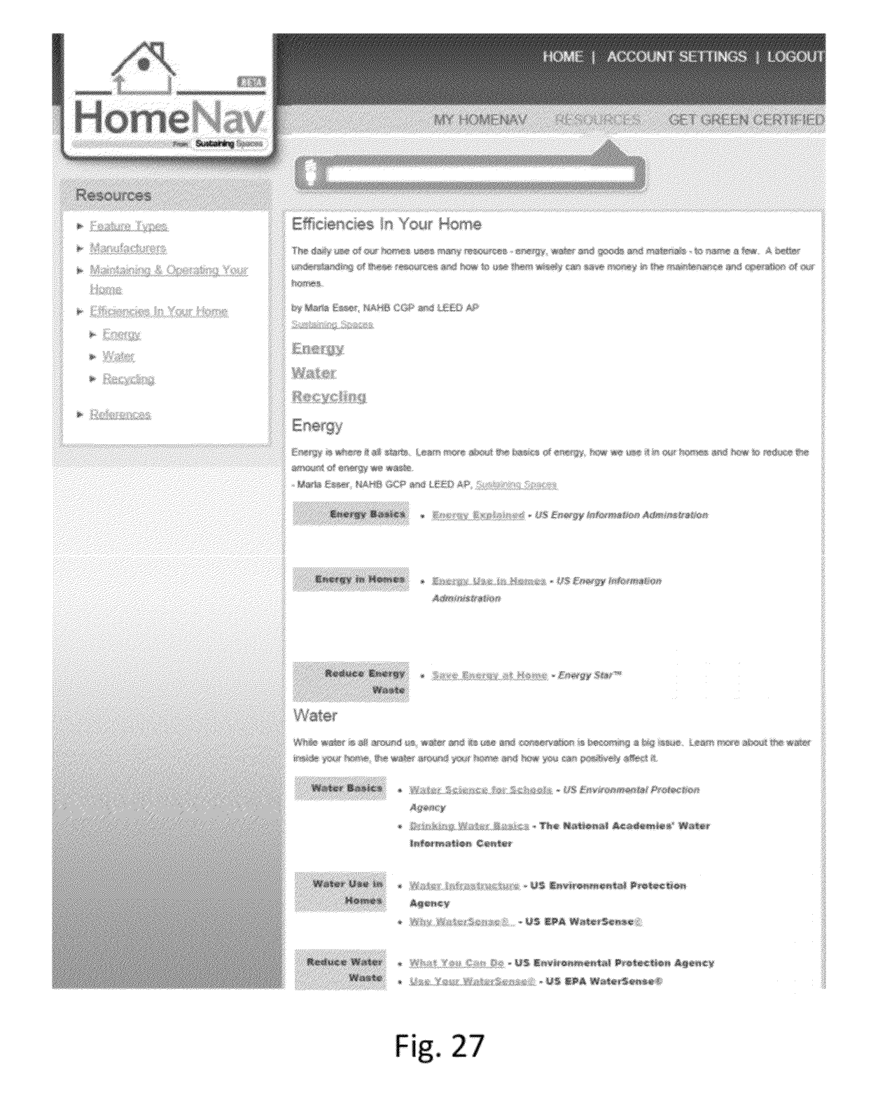

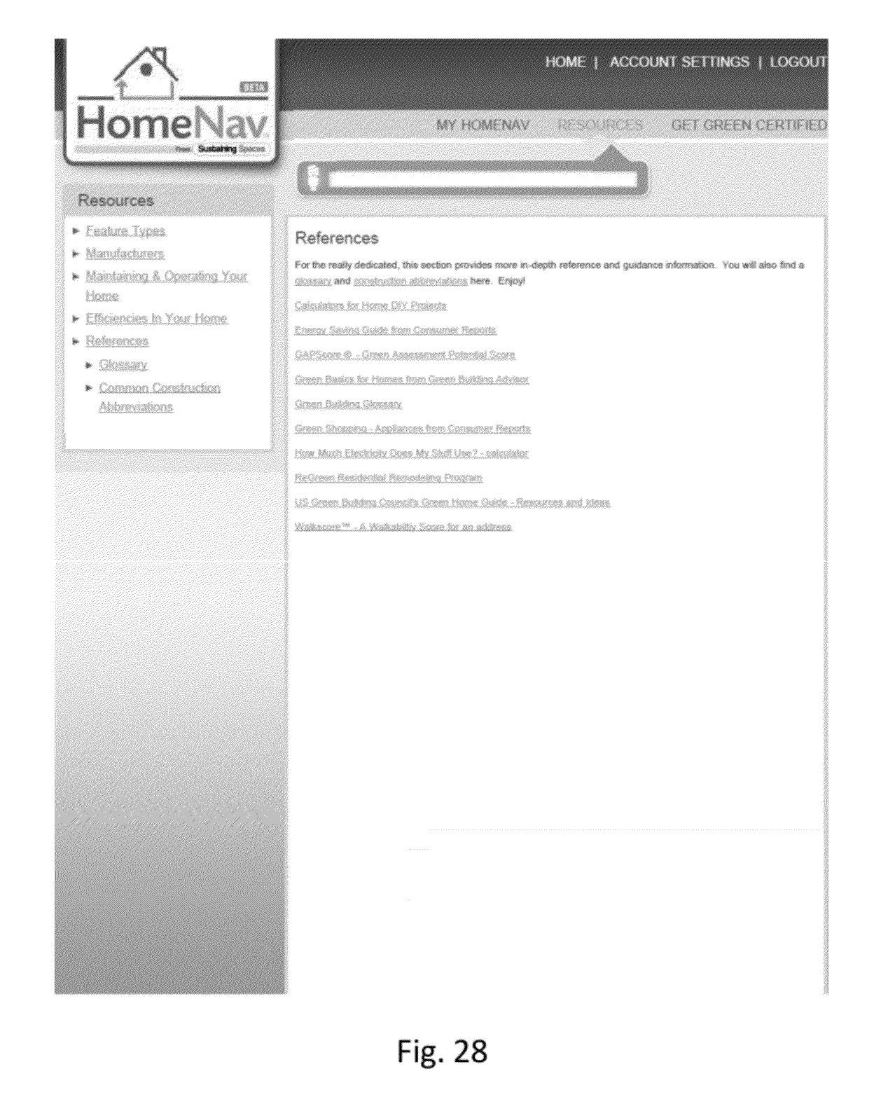

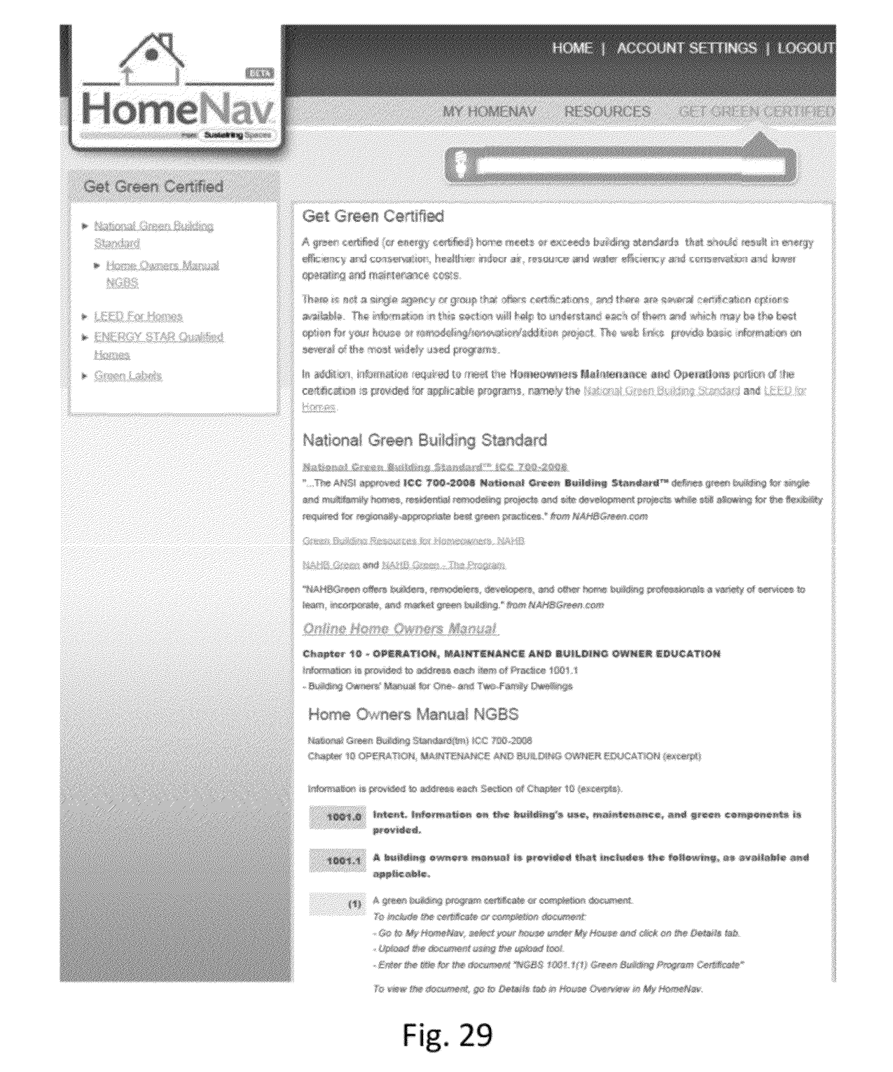

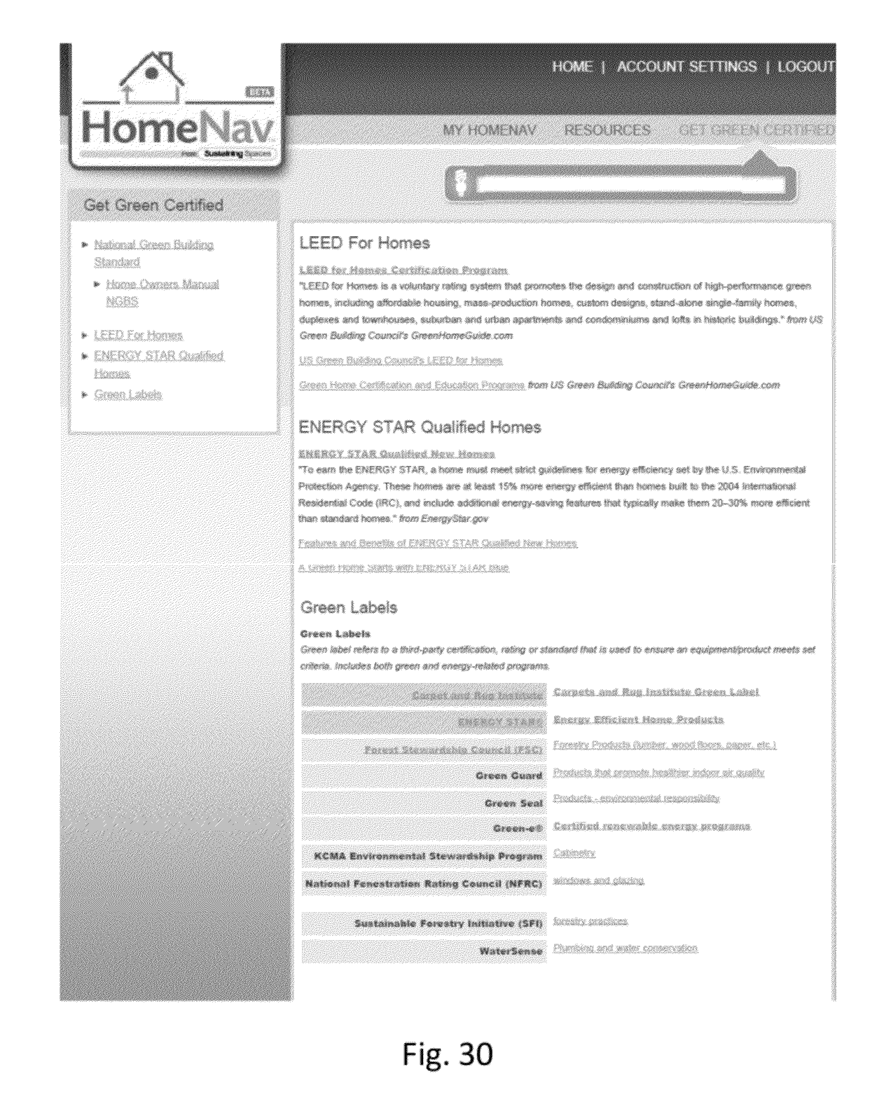

As discussed above, the general operation of the HomeNav system is shown in the flow chart of FIG. 2. Particular steps in the operation of the HomeNav system are further described below in relation to FIGS. 15-30. In operation, a new user account is created by clicking on the log-in button. At the log-in screen, the user creates an account by entering the required information. The account is protected by entering a password, confirming the password and providing an email address and a physical mailing address. When creating the account, the address information is for the registration of the account and does not necessarily need to be the same as the home that is going to be associated with the account. After the account is created, the user will have the opportunity to enter the information for the actual property or house (or multiple homes) that corresponds with the account. A promotional code may also be entered. The user agrees to the terms and conditions for using the system, and the account is created with the information that has been entered. The system sends an email to each new user an authorization is pending. When the authorization is received, the user can return and log into the system to gain access to the activated account.

Now we come to the main HomeNav screen where we are welcomed to HomeNav, and we see the three principle pieces of HomeNav. The first one is all about my house and this is where we will be spending a lot of time filling in the information about the various pieces of my house. The second piece is home owner resources, and this is really an education tool and resources to help home owners understand the different types of features in their homes, what different manufacturers may offer, tools for maintaining and operating your home, as well as the deeper references if you will for the hearty who want to learn more. Again, these are all resources on the web we are linking to. The third piece is over here Get Green Certified, and this is where we refer to the leading Green home building programs that are out here today—National Green Building Standard and LEED for Homes that comes from the US Green Building Council and the Energy Star Building Qualified Homes. Two of these, National Green Building Standard and LEED for Home, require home owner's manuals. We actually have an opportunity to specify further, and we will go through one of them since they are very similar. Again, these two sections are web resources that are available; but we will come back to these as well.

As discussed above, the HomeNav system has the option of being co-branded with industry member professionals and can provide advertising listings for contractors and service providers. For example, the HomeNav welcome screen shows a “Brought To You By” co-branding option for industry members. The screen shows the branding that a builder may add to the HomeNav accounts for their clients. The company may include as much information as desired, such as information about the company (name, address, phone, web site), and may include images such as a logo or pictures. The HomeNav system can also feature particular resources and manufacturers, such as at the top of the web page that lists the manufacturers. A manufacturer, distributor or other industry member may pay to have a featured listing on the HomeNav system. The featured listing can include a logo or other graphics, shading or other elements to emphasize or otherwise highlight the listing, and can be a part of a rolling feature list from multiple options. Different featured industry members would appear whenever the page is refreshed or revisited.

Lets start with the house, since it really makes the most sense. The first thing we do is to give a title to our house, and we will call this Matt's house. Then we put in the address of the house, and in this case it turns out that it is the same address as the user but it might not necessarily be. What will happen is that this specific house is actually going to be accessed, and this way the information can stay with the house as it is sold or passed along. We include the county, and this should be St. Louis County. Part of why we ask for County is that building codes and building regulations vary by county rather than by municipality. The house faces north, and we ask if the house has a basement or not, and if it is partially finished or completely finished. We ask for a rough estimate on the square feet; and if you don't have it, you don't have to fill it in. We'll take a rough guess.

The note section is a place we want to put anything we want to remember. We may want to include the year in which the house was built. We will guess it was built in 1948, and it was an addition in 1996. This is really just a place we can put notes to ourselves about the entire house.

Once we submit this information, it goes into a section that always appears on the side of HomeNav network. You will see on the left we have all the details about Matt's house. We pop up a Google map to see where the house is located and how it sits relative to the other things in the neighborhood. It is a nice way for the home owners get a grasp of what they are looking at. We'll then see five tabs at the top that is all information that is specific to the house. This is where we start to build house out in the HomeNav software if you will.

We start by floor. We give you an opportunity if you want to simplify it and only see the basics. We can start in the basement where we have the opportunity to start adding rooms. Many times we find in the basements, particularly in the St. Louis area, there may be mechanical rooms. We oftentimes find that, and we also have the unfinished portion, and we also have what we call the rec room that is very popular use for the basement in the St. Louis area. Now that we have created a couple of rooms, we can add features to each of those rooms.

The add feature can be anything that goes into that room that is attached to the house. It may include appliances. It may include flooring. It may include paint color, so we start by looking at the categories that are available. You can see we have all categories covering all of the different components of a house and what makes a house tick. Since we are in the mechanical room, how about us starting with heating, cooling and ventilation, which is usually in the mechanical room.

Once we have selected a category, then we can then select the type. Since we use a lot of gas furnaces in St. Louis, we'll start with that one. We can choose a manufacturer from our very comprehensive list of manufacturers, and we'll going to look for Lennox. Then we will choose an “L” for our Lennox gas furnace, which is right here. Once we have chosen the manufacturer and type, we can now have the choice of putting in our model information or it may pre-populated.

A lot of the information is going to be added here by the user. So what we've done is taken the information about the manufacturer and type to get them closer. What is cool about this is you will see when we're going to see click on this, we already have pre-populated information in the HomeNav database for the type and manufacturer. By entering the model, you don't have to select as much information. We're going to select Other, and this will bring us to a place to type in the model, and we're going to put in a 2-Stage 92% efficient gas furnace. I don't happen to have the serial number on this one, so lets make up one, 123456. We may want to include in the notes that it was installed in 2008, and we would want to know what year it was installed. Then we have the opportunity to add information from the web and from files we can choose that will allow us to further define. So lets say for instance we've gone to Lennox's website and pulled their information for the 2-Stage furnace. This is not going to be a live website, so please don't actually go there because I'm making it up. We can type in the website name and it will allow us to come back very easily to that web site when we go the View My Data site.

We can also choose a file from anywhere, and I'm going to choose something at random. We can choose a file and call it chosen file, and we can continue to add documents and add links. We can also add green labels, and this is where we specify if the actual component has a feature that makes it energy efficient, green or something else. This particular one is Energy Star so we have added that green label, and simply click on that add feature. All of the information we've added is captured in our database for this individual house.

When you look back at the actual feature of the furnace, you'll see title, the type of equipment it was, and you will see two gray blocks over here on the right. Each one of these gray blocks are information from the HomeNav database. All of the networks are in the HomeNav database, and they have been pre-populated and researched by HomeNav staff. Each and every website we put out here has a pair of human eyes that goes into before it is added to the database. We personally search and select every website we put out here. We also do the same thing for information about the actual features. These are third party sites we have put through a process that we feel provide objective information to our home owners and builder market about different capabilities of that feature. In this case, how to repair a gas furnace, tips and techniques of a gas furnace, we have added these to allow the home owners to have references and be able to refer to but not to be overwhelming.

In addition we have information from our database about the green label. In this case we have preselected some of the key Energy Star websites and included them including the Energy Star main website which we can click to quickly and easily as well as the federal tax credits which, although some of them are ending, are still of great interest for many home owners.

The last section is in the upper left hand corner. This is the information we, the user, have just entered. We have entered the model information, serial information, any notes and files or websites we have attached. We'll come back to these in another home, and show you how these work in pre-populated homes. You will see some valid web sites. What we have enabled about this one feature is to be presented in one easy block so as a home owner is experiencing issues and want to know how to maintain and operate a piece of equipment or feature, they can come to one place and find it. We can continue to add features to the house in the same manner.

If we are in the database, some of the information is already in here, and we may take advantage of it and don't have to add the website. For instance, we may want to select a dishwasher, and it's a Bosch. It turns out that I have a pre-populated and have a home that has used one, and there is actually a model in here that happens to be the model I want to choose. Any time I choose the model, it has already uploaded all of the features and green labels for me. When I add the feature and come back to it, select a few capabilities, all of the information is there for me, including the actual website for the model. Because this is really a feature that comes with a particular service when we are inputting HomeNav for our client or when we have specific manufacturer agreements to get details, this is not the standard level of detail that would be with the product. It is a capability that is an added feature in some cases, which is a nice case to have.

So in this manner we can continue to go through the house, populating the house. We can go the next floor and add more rooms. We can go the exterior of the house, add information about the garage, add information about the home exterior which might be the insulation, roofing, etc. From there we have a save print capability. We can actually have a print out for the home owner, especially since most times when the electricity goes out is when you need access to all of this.

From here we may want to move on and fill in additional information about the house, for instance, the utilities. We may include insert any utilities about the house simply by selecting the edit icon and adding in Laclede Gas as our natural gas provider. We can add our account number, if you like, the address; it is in St. Louis, Mo., so we may want to add that information in. We can add the phone number as well as website. Once we have added all that information, it is now very easy for us to access this any time we want. Now we can come to the actual information for the gas provider. We can continue to add information for the home owner and again a one-stop place for the home owners to come to and find information at their finger tips when they are ready. We can do the same thing for emergency information, contractors which may include people who helped build the home, worked on the home, HAV contractors, plumbers, painters if you want. Oftentimes when a builder is presenting this to a home owner, they will fill in their information, and the home owner had their own as they go.

The last one is details where we have an opportunity to add documents and links we want to add about the house. When we flip over to a populated house, we will show how this works to give you a better idea.

Now we will switch over to a house that has already been populated, and this will give us a better feel about a house that is functioning as is. As a matter of fact, this house was verified under the National Green Building Standard using the home owner's manual, and all the features filled in here. We have actually had an opportunity to test it with some of the bigger powers that be. As we start out with the home, we see the floors, this particular house we see it has a basement, two floors and an exterior. If we expand all of this, we'll start to see the various features that are in the home.

So in the basement for instance we have air purifiers, Geothermal and some plumbing. We call it a thermonatric valve. When we open it up, we see a fully populated feature which is the appliance, HAV, Geothermal HAV. Here we click for the actual specs for the unit, so we can go directly to the provider's web pages and see all of the information that is in here including that it is an Energy Star unit. We can go back to HomeNav and actually see a picture of the unit. We can also actually go the Energy Star web sites about the particular different products and click over and see that Geothermals are actually on the list for Energy Star products. If we look here and see Geothermals and Energy Star and see that it is a green certified product. We can also come back to all of the brand sites as well as all the information about basic Geothermals. We can present this information in a resource so that home owners who are considering Geothermal, for instance, can look at it as well even if it is not already in their house. This particular one is already in the house, and this is all the information about it like you can see my hands.

As we continue through the house, we can see information for the bathrooms, the master bathrooms. We can even include the paint colors. I don't know about you, but everybody I know say they lose their paint colors. This particular paint happens to be a low C or no C, no harmful compounds found in it, so it is a very safe paint. We talk from the spec sheets, linking very quickly to web links for the particular product that is being used as well as specifications or the third party certifications for the product. Again, this is all of the brand information, and all of the information we can find useful about painting.

Continuing through the house you can see it becomes a virtual replication of the house with information about all the features, all of the components of the house included. We can even include drawings and different pictures and any other computer files that we can add to.

Let's look at how we would edit one of these by using our little pencil, which is our editing tool, and it brings up the screen when we are adding a feature. Again, we have the capability to bring up the same categories, the same types, and we can, again with the manufacturer, and we can change the model number. If we know the serial number, we can add the serial number. We can continue to upload web links and files, so that the actual home owner may have a beginner fill in from the builder, or whomever who had worked on their home, and they can continue to add information. A nice capability is to continue to have this be a living growing document as the home owner continue to make changes and adapts to their home over time.

The last piece I want to show you in this house that is already populated is the exterior. The reason this is so important is that most home owners don't think about what is protecting them from the elements. One of the things we have found this very interesting is simply by educating the home owners on what the features are in their home, what the capabilities of their home are, they have a better understanding and a better appreciation of it. Oftentimes it is a better way to modify their behavior, for instance, they know they live in an efficiency saving house, they may choose to make more energy efficiency decisions.

We have actually included on the different components in the envelope down here at the bottom. For instance, this particular house sports something call superior walls which are precast concrete foundation which is fairly new technology. By having all of this information available to the home owner, they now have the additional education, learning about their individual home and how it is doing things. We have included information for the basement walls, the roof, the roof fence, sidings and windows.

Again, this is just another feature added, a little bit different about information the home owner knows about their homes. From here we can go to save print, and this is what we print out for the little book we present to the home owners. It is not all the links, but it is all of the information by floor, by room that is in their home, so they can have a quick reference and also kind of a shopping list if they ever need to access all of the components of their home.

Each of the five tabs for the home owners have the same save, print capabilities. For instance, for utilities, we can have a very quick reference like electricity for the city where the home is located, for natural gas, for recycling, very quick links where to go for this information. They can have the same type of information for emergencies not only for natural gas, fire, police, but they may want to add Poison Control Center if they have children, or other local emergencies and family contacts for emergencies. For contractors we include different groups that worked on the home that the builder actually opted to have in here. In the case of a newly built home, typically, it is not everyone who worked on the home, only the ones they want to brag about, and the ones they want the home owner to be aware of, and also the ones to contact—electrician, painter, plumber are typically they ones we see. Again, we have the save print capability so they have a quick reference and can almost use it as an address book.

Lastly are the details. In the same manner you can attach a web site to a piece or feature, and you can attach the same type information or website to the entire home. This is really a good place for us to put the plans, which we can see down here, simply by clicking and we can actually bring the plan up. Now we see the plan for the home, easily accessible for the home owner. We can go through all of the plans. We have pictures of the actual foundation going in. We have a boundary summary, and we have some place holders for other pieces of information coming in, green building feature lists, and the certificate that we won't get until the home is finished being certified. We can insert those when they come. We have also included safety valve control and shut-off drawings. In the case of an emergency, this is another document we like to print out so the home owner can have it in their hands for quick reference. In the case of an emergency, they know how to shut off things in their homes quickly.

We also include a number of links. These are local information that will help the home owner to live greener in this home. If this is a green certified house, it is included locally for them to live. In HomeNav we have the resources for them to live green nationally, but we have to drag down to these. So we can include recycling powers, transportation, and that raps it up.

Now I want to move into the resources part of HomeNav. Homeowner resources tells the home owner all kinds of information and allows the home owner to research and understand other things of what may be specifically installed in their home. Let's start with feature types where we have a comprehensive listing of all the feature types that are listed in the HomeNav database. These are the same features a user can select when they build their home, when they are populating it, and they are in a manner where we can go easily and look at them. For instance, air conditioning, we want to learn more about energy efficiency ratings, we go to air conditioners and click on the link. We go to a web site that talks about energy efficiency ratings.

One of the philosophies of HomeNav was not to reinvent the wheel but to link the information that was already available on the web, but where we had already done the web research and web detective work to determine that this is a web site that is valuable to the home owner. So each of these five sites that you see for air conditioners that HomeNav staff have selected include introductory and helpful information for the home owner. We continue in this fashion all the way through the alphabet. For instance, moving down to Ps, we can look at paint and we can go to a web link on how to choose an exterior paint.

We have a process that we go through to select each of these features that we will detail on our written instructions, but essentially, for all feature sites. We look for third party sites. We start with government sites, such as the Department of Energy, EPA, which actually both have a huge amount of information. From there we have a number of third party sites that we rely on things such as consumer reports, i.e., other public information, really something that is in the public's eye. The key to this is that it must be something valuable to the home owner. We try very hard to find sites that do not sell products that simply provide advice. We are sure we are good to link to them and; of course, we need to periodically come back and test links.

Resources also include information about all of the manufacturers in the HomeNav database. By clicking on the manufacturers list similar to what we saw in feature sites, presented in alphabetical order, that are going to give us some of the key web sites each of the manufacturers. When we start off, we typically see a main web site for the manufacturers such as we see for Air King. We look for things such as FAQ, product information, contact information, warranty information when we can find it. Oftentimes if there is a particular product group that the manufacturer is known for, we will also link to that. For instance, if we click down to GE Appliances, and GE is a huge company. We specifically go the GE Appliance web site since that is the piece of concern for the home owners builder industry. From there we link to the FAQ page, the product, service and contact us page. Many of the manufacturer web sites are set up slightly different, so we find the contact information includes warranty information and other customer service information. We go through a process where we select three to five web sites that will be most useful to the home owner in identifying problems and taking care of their equipment from that particular manufacturer or in learning more about that particular manufacturer.

You will also see as we look at some of these web sites, they may also include Energy Star information, such as the one that I just passed. They may include tax credits. Right here Heat & Glow include some tax credit information on their web site which we will get a quick preview of. For instance, they will tell you which of their products may qualify for a tax credit. Again, this is useful information for the home owner. It may include a product registration, such as for Honeywell. Oftentimes we also find information from Home Depot and Lowe's, some of the big box stores because they may have private label products. For instance, some ceiling fans are private label through Home Depot; we actually include Home Depot and Lowe's as a manufacturer. They are not really, but we include them so we can reference their information. As we stroll down, this one actually has a warranty page on their web site, and we actually link onto that.

Each manufacturer requires a set of eyes, that go through steps in our process to select the web sites which will be most useful to our home owners. One of the very unique capabilities of HomeNav is each feature is researched by a HomeNav person, a staff member, and then that information is captured in the HomeNav database and then put out for our user's access.

Maintaining and operating one's home is probably the next biggest challenge. Once we have our home presented to us whether it is an existing home or a new home, now we have to figure out how to live in it and how to maintain it. Maintenance and operations of a home is really just like any piece of equipment that really impacts its durability, how well it functions, and how well it performs. By providing this information to home owners they can easily get to it, it is so critically important; and many of us probably know more about how to maintain our cars than our homes. This section is a nice way for home owners to get some leverage for better maintaining their home. Again, we are linking to established web sites that are already out there, we are vetting them through our process. We go through the same process with this.

We present a number of checklists that enable the home owner to choose by seasons. For instance, we present a list for spring. This one happens to be from this old house that presented some really nice information on how to do a number of things that need to be done to be done to one's house in the spring. Giving them this spring upkeep is a way to give a start and we continue on our checklist through the seasons.

We also have safety and prevention information, and an overall checklist information. In addition to the checklist, we also provide a number for references for maintenance. For instance, the National Association of Home Builders offers a really comprehensive home maintenance web site they host that includes all kinds of information about maintaining your home down to what should be in your tool kit. In addition we may link this very comprehensive guide from one of the extension programs at one of the universities alphabetical literally. Just by linking on it, we can learn just about anything we want. For instance, looking for how to take care of porcelain enamel kitchen fixtures, we can find some really helpful information. One of the things we have learned is there is tons of useful information, and there is so much out there that home owners don't know how to find it. We then become the targeted avenue to get to that information. Understanding what home owners needs and taking them to that is a big piece of what we provide.

The third piece of maintenance may be specific for a green home. A green home may have some specific capabilities that have to be preserved through maintenance. We have to talk to home owners about what they need to do to make sure they maintain their home in a manner to keep it green.

HomeNav also allows us to share with home owners education about different aspect of their home that may go above and beyond specific types, or the manufacturers or for the maintenance, so efficiencies in your home are a great place to start since we didn't have any information any place else. This is an opportunity for us to do a couple of things. One is to present the home owner with basic educational information that is presented in an easy to understand format. It is also an opportunity in this little introductory section for us to host guest experts so we have an opportunity to find somebody that is an energy expert, to write the introduction and cross link it, so this is an opportunity for us to share the wealth with even more companies and people out there. We can then present each of the topics we wish to present. Lets choose a topic, actually lets choose water because it is more fun about it talks about energy. Again we have another introduction where we can host an guest expert if we wish, or we can write it ourselves. We have a lot of flexibility with this.

Then we present an educational section that is a little bit unique. All of our sections are set up in this format where we have three basic sections. The first is basic the primer, the 101 information. Again we try to go to as many publicly available web sites as possible. We individually search for each web site before we put it out here. We found for instance some great introductions to the basics for water from a couple government web sites, from the EPA and the National Academies Water Sites. Once we set the stage if you will with the basics for water, we then talk about the problems and issues about water, the infrastructure from the EPA, and why water sense, which is actually a water conservation program which talks about the problems and issues. The last part is what actually we can do to reduce water waste. So what can a home owner do; this is the solution aspect and what you can do to use water sense are two aspects of what their solutions are.

What is really unique about this is the fact that we present a drilled out structure that takes a topic and breaks it down into very easy to understand components, and we can continue to support as many or as few as we wish. For instance, we have recycling, why recycle, what you can recycle, how it affects energy, where do I find recycling resources, so that is my solution aspect. This is an opportunity for us to build on draft solution, but it gives us a way to continue to spread the education. We also can link back to any of our resources about to our feature types and maintenance as well as reaching out to our reference section.

The last part is references. This is the part where we tell those who are not vain of heart to go because this is where we start to get into the deeper aspect of the resources that are available on the web, particularly concerning energy efficiency resources, more of the green topics. This is also where we include a glossary of terminology used in home owner and building capabilities. This is where we have a common construction abbreviation glossary. We have calculators for home do-it-yourself projects, all kinds of green shopping, green building glossaries, remodeling green programs. Again, deeper information that provides the home owner with more references if they would like to build. Again, this is a link we have vented, and as this grows, we will break it down into sub-groups with that same philosophy of providing that basic information and either problem or solution oriented information for everything as we go forward. For instance, here is a green building glossary that was hosted by the National Association of Home Builders, a great web site. We simply put our users into that web site by linking them to things we already know. Again this will be things will again be a living breathing document as we find new web sites; and as we go through the process with them, we will add and subtract and change them our web sites.

The last section of HomeNav is an optional section for most home owners. This is a Get Green Certified section. We left this is a publicly access section to go to because we thought homeowners might be a little bit curious in their lives about getting green, and this was a way to find out what some of the standards are, and what and how to understand it. The active users of get green will be certified builders and remodelers and others involved in helping a home become green certified through one of the national green programs, National Green Builders Standard or LEED for Home. Why we care is because if a buider or remodeler is certifying a home through one of these programs, both National Green Builders Stand and LEED for Home require a home owner's manual to pass certification. Since this is a requirement, the entire HomeNav web site can serve as their home owner's manual and meet the requirements for them to certify the house as green. It is important for that sector of the market and a little bit unique way to approach it. Many builders and remodelers are starting to use PDF files and loading them on USB drives or CD Roms, but I have yet to see anyone putting it on a web site utilizing this link or technology or using that capability.

Let's go through the National Green Builders Standard since it is the one mostly used by the people I'm in touch with. The LEED for Home Owners Manual looks similar to what we are going to see here. We also include in each of these areas, links to actual programs, resources that the programs may provide for home owners. You will see the actual green site for the NAHP as well as the program itself. We also link to the standards if more information is required and first and foremost the online home owner's manual.

This site actually walks us through more for a builder or remodeler walks us through the capabilities in the process of making sure all of the information is in HomeNav that is required to meet the different requirements for the home owner's manual. We have actually mirrored the way it is laid out in the Standard in the document so the builder can follow along exactly as their code book is laying it out for them. That is what all the 1,001 dot zeros means that we are following the structure the way it is laid out for them. The way it is laid out is how we first describe what the element is or the practice, and then in italics we give them instructions on how to fill in the information, and then how to view this information. This will also allow the home owner that might be referencing this later on down the line when this is filled in, and they want additional information, it allows them to see how to view information for that specific section. Most of the information in this section is in the resource section as well. We cross link as much as possible, and a lot of the local information, we go to see details is in the actual house itself in those five tabs, back in My Home in HomeNav.

As we go through the different elements, we see a lot of these capabilities are attaching documents to prove it is certified. We have all the product manuals which again is clicked to My HomeNav which is where we started. We have a number of capabilities that require information on local programs. With a national viewpoint, we didn't want to specify how to do for one locale and not others. We have been able to locate national resources such as National Recycle Coalition, and we have actually given them instructions about going to these web sites, identifying their local resource, and bringing it into the detailed section of My HomeNav so that the information is available for the home owner there.

What this is it doing is we give the instructions to the builder or whoever is completing the green certification, the instructions on how to grab the information from the national site and put it into My HomeNav. For example, we found three web sites that might apply for the St. Louis Metropolitan area for recycling. There is a web site for St. Louis City, St. Louis County and St. Charles County, so these might be one or more of the web sites that we insert into the details of My HomeNav. Most home owners are never going to have to come to the Get Green Certified piece. It is really more intended for the builders and remodelers that are certifying the house and others, verifiers that are involved in the program. As such, this information are both a back side and front side. The user is also welcome to come to the site and see the guts behind it all.

As we stroll through we find a few more local information kinds of things, and then we start go into more resource information oriented that is being populated in the resource side of the document. This is information about different energy saving, water saving techniques that may be used around the house. For instance, this one is on CFL and LED lighting which are both high energy efficiency lighting, we include practices to conserve water and energy. We include information, more local information about maintenance, different hazards around the house and again ways to access information about those, organic, use of your yard fertilizers and pesticides around the home. These all relevant information required through the home owner's manual through the different standards that we continue to go through. What is key to all of this is it gets into resources as well which is in a format the home owner can share just like what we saw in the resources earlier. These are also available in that area.

The last component of the Get Green Certified is a reference section about the green labels that are used in programs. Again, this is a reference and also available through the home resources. Again it is way for them to learn about all the different labels out there and to access to tell you about the product has already been approved, or third party verified or some other way that already states that it meets the expectation or says it does. For instance, we have green labels for carpets and rugs. We have Energy Star for energy efficient home products, we have Green Guard which actually promotes healthier indoor air quality, and we even have a Kitchen and Cabinet Manufacturer Association and Environmental Steward Program for Cabinetry. There are a lot of programs out there. This is simply a resource space to educate home owners, builders and remodelers on what labels are out there, what they mean and more about them.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A system for providing a plurality of users with an organizational template for an interactive home manual, comprising:
a centralized database storing a plurality of datasets, said datasets comprising user account information, home locations, home feature descriptions, home feature information, and a set of correlations between said user account information, home locations, home feature descriptions and home feature information;
a centralized computer processor comprising an account management module, an interactive user operations module, and an administrative operations module, wherein said account management module correlates a plurality of accounts for the users with said user account information in said centralized database, said user operations module produces said set of correlations for the users' respective accounts, and wherein said administrative operations module manages said database;
a centralized communications module in local communication with said centralized computer processor and said centralized database and in networked communication between the users and said centralized computer processor.

2. The system of claim 1, wherein said home locations further comprise a unique address, a floor level, and a plurality of room selections, and wherein said set of correlations identify a room for each of said home features associated with said unique address.

3. The system of claim 1, wherein said home feature information comprises general feature information and user-specific information.

4. The system of claim 3, wherein at least one user enters said user-specific information into a dataset in said database.

5. The system of claim 3, wherein said user-specific information from the users is transformed into general feature information that is shared between the users.

6. The system of claim 3, wherein the users enter said home feature information into said centralized database according to the respective accounts of the users using a plurality of codes correlating pre-populated information in said centralized database with a plurality of home features.

7. The system of claim 6, further comprising a code entry device in networked communication with said centralized database through said centralized communications module.

8. The system of claim 7, wherein said code entry device is a mobile communication device comprising a data input mechanism and a corresponding software application, wherein said data input mechanism is selected from the group of mechanisms consisting of an optical scanner, an RFID scanner, a magnetic strip scanner, a keypad, a touch-screen, a speech recognition microphone, and any combination thereof.

9. The system of claim 1, wherein said home feature information is comprised of manufacturer URLs, resource URLs, reference URLs, and electronic files stored centrally in local communication with said computer processor.

10. The system of claim 1, wherein said centralized computer processor further comprises a calendar module and said wherein said datasets stored in said centralized database further comprise maintenance reminders.

11. A method for providing a plurality of users with an organizational template for an interactive home manual, comprising the steps of:
storing a plurality of datasets in a centralized database, said datasets comprising user account information, home locations, home features, information related to said home features, and a set of correlations between said home locations and said home features;
correlating a plurality of accounts for the users with said user account information in said centralized database using an account management module of a centralized computer processor;
producing said set of correlations for the users' respective accounts using a user operations module of said centralized computer processor;
managing said database using an administrative operations module of said centralized computer processor; and
coordinating local communications and networked communications, wherein said local communications are between said centralized computer processor and said centralized database and said networked communications are between said centralized computer processor and the users.

12. The method of claim 11, wherein said producing step further comprises the step of selecting information for a home feature from a plurality of options provided by said database.

13. The method of claim 11, wherein said producing step further comprises the step of inputting information for a home feature that is not in a set of options provided by said database.

14. The method of claim 11, wherein said producing step further comprises the steps of entering a plurality of codes to said centralized computer processor and cross-referencing said codes with corresponding home feature information stored in said centralized database.

15. The method of claim 14, wherein said entering step further comprises the steps of inputting at least one of said codes into a mobile communication device, establishing a communications link between said mobile communication device and said centralized computer processor for said networked communications, and communicating said inputted code from said mobile communication device to said centralized computer processor.

16. The method of claim 11, further comprising the step of populating a seller's disclosure statement for a real estate sale with information from said database.

17. The method of claim 11, further comprising the step of defining furnishings and appliances at one home location to be transferred to another home location.

18. An automated data entry system for a plurality of mobile communication devices to upload information into an interactive home manual, comprising:
a centralized database storing a plurality of datasets, wherein said datasets comprise user accounts, home locations, home features, home feature codes and a plurality of correlations between said datasets, wherein a first set of correlations is between said home feature codes and said home features, a second set of correlations is between said user accounts, said home locations and said home features, and a third set of correlations is between said home features and a set of links to information related to said home features, wherein said links point to at least one of a remote online resource, a centrally stored resource and a local-user stored resource; and
a centralized computer processor in local communication with said centralized database and in networked communication with the mobile communication devices, wherein said centralized computer processor receives from the mobile communication devices code data defining said home feature codes and performs said first set of correlations.

19. The system of claim 18, wherein said code data is received from the mobile communication devices in a raw form from at least one of an optical scan, an RFID scan, a magnetic strip scan, a keypad, touch-screen, and a speech recognition microphone, wherein said centralized processor translates said raw form into said home feature code.

20. The system of claim 18, wherein said code data is received from the mobile communication devices in a processed form as said home feature code from at least one of an optical scan, an RFID scan, a magnetic strip scan, a keypad, touch-screen, and a speech recognition microphone.
